(19) United States
(12) Patent Application Publication
(10) Pub. No.: US 2007/0297307 A1
(43) Pub. Date: Dec. 27, 2007

(54) Write Correction Circuit and Write Correction Method

(75) Inventor: Kouichi Nagano, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd, Osaka (JP)

(21) Appl. No.: 11/665,718

(22) PCT Filed: Sep. 12, 2005
(86) PCT No.: PCT/JP05/16723

§ 371 Date: Apr. 18, 2007

(30) Foreign Application Priority Data
Oct. 18, 2004 (JP) 2004-303451

(51) Int. Cl. G11B 7/0045; G11B 7/125

(52) U.S. Cl. 369/53.25

(57) ABSTRACT

A write correction circuit (100) includes, in its input stage, a pulse modification circuit (11) for removing patterns (sections) included in a write pulse signal (s1), which patterns have lengths outside a range that is previously determined as a section length of the write pulse signal, and outputting a modified pulse signal (s1) that is obtained by modifying the waveform of the write pulse signal, and write correction is performed to the modified pulse signal (s11) that is obtained in the pulse modification circuit (11). Thereby, highly precise write correction can be performed to the write pulse signal (s1) inputted to the write correction circuit (100).

### TECHNICAL FIELD

The present invention relates to a write correction circuit for correcting an inputted recording information waveform in an information recording apparatus for recording information on a recording medium by irradiation of laser light.

### BACKGROUND ART

When recording information on a recording film of a rewritable recording medium, a pattern of a mark and a space according to inputted recording waveform information (pulse signal) is formed on the recording film. When reading the information from the recording medium, the pulse signal is obtained by detecting the lengths of the mark and the space which are formed on the recording film, and the information recorded on the recording medium is obtained from the pulse signal. Since the information of the pulse signal written in the recording film corresponds to a boundary of the mark and the space, it is important how an end of the mark or the space is formed at an accurate position on the recording film when recording the information on the recording medium.

Therefore, when writing the information on the recording medium, write control for controlling a write address, a write current value, and a write timing has conventionally been carried out according to the pulse signal so that marks and spaces are formed in correct positions.

Conventionally, the above-mentioned write control has been realized by controlling a recording energy beam with plural power levels, or controlling a recording energy beam so as to have plural pulse widths in the time axis direction, or controlling the write timing so as to be shifted forward or backward according to the mark/space pattern (for example, refer to Patent Document 1: Japanese Patent No. 2563322, Patent Document 2: Japanese Patent No. 265094, Patent Document 3: Japanese Published Patent Application No. Hei. 11-86291, and Patent Document 4: Japanese Published Patent Application No. Hei. 11-283249).

Hereinafter, a conventional write correction circuit will be described.

FIG. 27 shows a construction of a write driving system in a conventional information recording apparatus. In FIG. 27, reference numeral 1 denotes a write correction circuit for correcting an inputted recording waveform information (pulse signal), numeral 2 denotes an optical disc as a recording medium, numeral 3 denotes a motor for rotating the optical disc 2, numeral 4 denotes an optical head for reading information recorded on the optical disc 2 or recording information on the optical disc 2, numeral 5 denotes a system controller for controlling the information recording apparatus, and numeral 6 denotes a laser driving circuit for oscillating a semiconductor laser included in the optical head 4.

FIG. 28 is a block diagram illustrating the construction of the write correction circuit in the information recording apparatus shown in FIG. 27. In FIG. 28, reference numeral 7 denotes a space/mark length detection circuit for detecting a space length and a mark length of the pulse signal, numeral 8 denotes an address generation/timing control circuit for controlling the write address, the write current value, and the write timing for writing information in the optical disc 2, according to the space length and the mark length that are detected by the space/mark length detection circuit 7, numeral 9 denotes a multiple-phase signal output circuit for generating multiple-phase signals from a clock signal and outputting the same, and numeral 10 denotes a timing generation circuit for generating a write correction signal as a pulse signal after correction, using the output of the address generation/timing control circuit 8 and the output of the multiple-phase signal output circuit 9.

Hereinafter, the operation of the conventional write correction circuit constituted as described above will be described.

Initially, the optical disc 2 is rotated at a constant linear velocity by the motor 3. Then, information that is recorded by record marks on the optical disc 2 is read with the optical head 4. During writing, the recording waveform information (pulse signal) that is transferred through the system controller 5 is corrected by the write correction circuit 1, and thereafter, the laser driving circuit 6 oscillates the semiconductor laser in the optical head according to a write correction signal as the corrected pulse signal, whereby the write correction signal is written as a record mark in the optical disc 2.

In the write correction circuit 1, initially the space/mark length detection circuit 7 detects the lengths of the space and the mark from the pulse signal s1, and the address generation/timing control circuit 8 controls the write address, the write current value, and the write timing for writing information in the optical disc 2, according to the detected space length and mark length. On the other hand, the multiple-phase signal output circuit 9 generates plural phase-shifted signals from the clock signal s2. Then, the timing generation circuit 10 generates a write correction signal by using the output of the multiple-phase signal output circuit 9 and the output of the address generation/timing control circuit 8.

### DISCLOSURE OF THE INVENTION

### Problems to be Solved by the Invention

As described above, the conventional write correction circuit 1 performs write correction on the assumption that the binarized recording waveform information (pulse signal) s1 inputted to the write correction circuit 1 is correct.

Usually, the ranges of the section lengths (space length and mark length) of the pulse signal s1 are determined according to, for example, the type of the recording medium on which the pulse signal is written, or the write mode (for example, 3T˜11T).

However, there are cases where a too-short pattern (e.g., “1T” or “2T”) or a too-long pattern (e.g., “12T” or more) having a space section or a mark section of a length outside the predetermined range, which is unacceptable as an input pulse signal, may be included in the pulse signal s1.

When such unacceptable pattern is included in the pulse signal s1, the conventional write correction circuit 1 cannot perform an appropriate processing to the unacceptable pattern, and thereby desired write correction cannot be realized.

The present invention is made to solve the above-described problems and has for its object to provide a write correction circuit and a write correction method which can always realize desired write correction to a pulse signal inputted to the write correction circuit.

### Measures to Solve the Problems

In order to solve the above-mentioned problems, a write correction circuit of the present invention comprises a pulse modification circuit for modifying the lengths of space sections and mark sections in a write pulse signal for recording information on a recording medium, the space sections and mark sections having the lengths which are outside a range that is previously set as a section length of the write pulse signal; a space/mark length detection circuit for detecting the space length and the mark length of the write pulse signal, which are modified by the pulse modification circuit; an address generation/timing control circuit for performing address generation and timing control when recording information on the recording medium, on the basis of the outputs of the space length and the mark length that are detected by the space/mark length detection circuit; a multiple phase signal output circuit for generating multiple phase signals by shifting the phase of an input clock signal, and outputting the multiple phase signals; and a timing generation circuit for generating a write correction signal on the basis of the output of the address generation/timing control circuit and the output of the multiple phase signal output circuit, and outputting the write correction signal.

Therefore, in the write pulse signal inputted to the write correction circuit, a portion having a length outside the range that is previously set as the section length is modified, and thereafter, write correction is carried out using the modified pulse signal, thereby performing highly precise write correction for the write pulse signal.

Further, in the write correction circuit of the present invention, the pulse modification circuit includes a space/mark counter for detecting the count values of space sections and mark sections of the write pulse signal, and outputting the detected count values; a reference value holding circuit for holding, as a reference value, a value shorter than the length that is previously set as the section length of the write pulse signal; a comparator for comparing the count value outputted from the space/mark counter with the reference value to detect a period in which the count value becomes equal to or smaller than the reference value; and a selection circuit for receiving the write pulse signal and a signal that is outputted from the selection circuit at an immediately previous timing, and selecting and outputting the signal that is outputted from the selection circuit at the immediately previous timing during the period in which the count value is equal to or smaller than the reference value, which period is detected by the comparator, while selecting and outputting the write pulse signal during other periods.

Therefore, it is possible to remove the patterns (sections) which are shorter than the length that is previously set as the section length of the pulse signal and are unacceptable as inputs, from the inputted write pulse signal.

Further, in the write correction circuit of the present invention, the space/mark counter includes a space counter for counting space sections of the write pulse signal; a mark counter for counting mark sections of the write pulse signal; an edge detector for detecting a rising edge and a falling edge of the write pulse signal; and a switching circuit for switchingly outputting the count value of the space counter and the count value of the mark counter at the timings of the rising edge and the falling edge which are outputted from the edge detector; and the comparator in the pulse modification circuit compares the count value of the space section or the mark section outputted from the switching circuit with the reference value, and outputs a signal that is outputted from the selection circuit at an immediately previous timing when the count value of the space section or the mark section is equal to or smaller than the reference value, while the comparator outputs the write pulse signal when the count value is larger than the reference value.

Therefore, a mark section equal to or smaller than the reference value and a space section equal to or smaller than the reference value, which are included in the inputted write pulse signal, can be modified to a space section and to a mark section, respectively. As a result, it is possible to remove the patterns (sections) in the inputted write pulse signal, which are shorter than the length that is previously set as the section length of the pulse signal and are unacceptable as inputs.

Further, in the write correction circuit of the present invention, the space/mark counter includes a space counter for counting space sections of the write pulse signal; a mark counter for counting mark sections of the write pulse signal; an edge detector for detecting a rising edge and a falling edge of the write pulse signal; a switching circuit for switchingly outputting the count value of the space counter and the count value of the mark counter at the timings of the rising edge and the falling edge which are outputted from the edge detector; and a section delay circuit for continuously outputting the count value of the space section or the mark section which is outputted from the switching circuit at an immediately previous timing, during the period in which the write pulse signal rises and the period in which the write pulse signal falls; and the comparator in the pulse modification circuit compares the count value of the space section or the mark section outputted from the section delay circuit with the reference value, and outputs a signal that is outputted from the selection circuit at an immediately previous timing when the count value of the space section or the mark section outputted from the section delay circuit is equal to or smaller than the reference value, while the comparator outputs the write pulse signal when the count value is larger than the reference value.

Therefore, in the write pulse signal, the section lengths of a mark section and a space section which are equal to or smaller than the reference value can be modified. As a result, it is possible to remove the patterns (sections) in the write pulse signal, which are shorter than the length that is previously set as the section length of the pulse signal and are unacceptable as inputs.

Further, in the write correction circuit of the present invention, the pulse modification circuit includes a period restriction circuit for restricting the period detected by the comparator to a length equal to or shorter than a predetermined period length; and the selection circuit selects and outputs a signal that is outputted from the selection circuit at an immediately previous timing, during the period that is detected by the comparator and restricted by the period restriction circuit, while the selection circuit selects and outputs the write pulse signal during other periods.

Therefore, when modification for extending a mark section and a space section which are included in the write pulse signal and are equal to or smaller than the reference value is carried out, the section lengths after the modification are restricted to a predetermined length or shorter so that a pattern (section) which is longer than the length that is previously set as the section length of the pulse signal is not included in the write pulse signal after the modification. As a result, more precise write correction can be carried out.

Further, in the write correction circuit of the present invention, the space/mark counter includes a section delay circuit for continuously outputting the count value of the space section or the mark section that is outputted from the switching circuit at an immediately previous timing, during the period in which the write pulse signal rises and the period in which the write pulse signal falls; and a count value selection circuit for selecting either the output from the switching circuit or the output from the section delay circuit on the basis of an externally inputted selection signal; and the comparator in the pulse modification circuit compares the count value of the space section or the mark section which is outputted from the switching circuit with the reference value when the output from the switching circuit is selected by the count value selection circuit, and compares the count value of the immediately previous space section or mark section which is outputted from the section delay circuit with the reference value when the output from the section delay circuit is selected.

Therefore, when modifying patterns (sections) included in the inputted write pulse signal, which are shorter than the length that is previously set as the section length of the pulse signal and are unacceptable as inputs, it is possible to select, as a modification method, either a method of removing the mark section and the space section that are included in the pulse signal and are equal to or smaller than the reference value, or a method of extending these sections, thereby performing more appropriate correction for the write pulse signal.

Further, in the write correction circuit of the present invention, the pulse modification circuit includes a space/mark counter for detecting a first count value that is a count value of a space section or a mark section of the write pulse signal, and second to N-th count values that are count values of mark sections or space sections which are by 1˜(N−1) pieces (N: integer not less than 3) previous to the first count value; a reference value holding circuit for holding plural reference values that have previously been set for each combination of N pieces of count values from the first to N-th count values which are outputted at the same timing from the space/mark counter; a comparator for comparing the first count value with a reference value that is selected according to the combination of the N pieces of values to detect a period in which the first count value becomes equal to or smaller than the selected reference value; and a selection circuit for receiving the write pulse signal and a signal that is outputted from the selection circuit at an immediately previous timing, and selecting and outputting the signal that is outputted from the selection circuit at the immediately previous timing during the period in which the count value is equal to or smaller than the reference value, which period is detected by the comparator, while selecting and outputting the write pulse signal during other periods.

Therefore, the reference value can be selected according to the plural section lengths of the pulse signal, and consequently, more appropriate correction can be performed to the write pulse signal.

Further, in the write correction circuit of the present invention, the pulse modification circuit includes a space/mark counter for detecting the count values of space sections and mark sections of the write pulse signal, and outputting the detected count values; a reference value holding circuit for holding plural pieces of reference values that have previously been set for plural kinds of writing modes for writing the write pulse signal on the recording medium, respectively; a comparator for comparing the count value outputted from the space/mark counter with a reference value that is selected according to the writing mode of the write pulse signal to detect a period in which the count value becomes equal to or smaller than the selected reference value; and a selection circuit for receiving the write pulse signal and a signal that is outputted from the selection circuit at an immediately previous timing, and selecting and outputting the signal that is outputted from the selection circuit at the immediately previous timing during the period in which the count value is equal to or smaller than the selected reference value, which period is detected by the comparator, while selecting and outputting the write pulse signal during other periods.

Therefore, the reference value can be varied according to the type of the write mode for writing the pulse signal in the recording medium, thereby modifying the waveform of the write pulse signal more appropriately.

Further, in the write correction circuit of the present invention, the pulse modification circuit includes a space/mark counter for detecting the count values of space sections and mark sections of the write pulse signal, and outputting the detected count values; a reference value holding circuit for holding plural pieces of reference values that have previously been set for plural kinds of recording media on which the write pulse signal is written, respectively; a comparator for comparing the count value outputted from the space/mark counter with a reference value that is selected according to the recording medium on which the write pulse signal is written, thereby to detect a period in which the count value becomes equal to or smaller than the selected reference value; and a selection circuit for receiving the write pulse signal and a signal that is outputted from the selection circuit at an immediately previous timing, and selecting and outputting the signal that is outputted from the selection circuit at the immediately previous timing during the period in which the count value is equal to or smaller than the selected reference value, which period is detected by the comparator, while selecting and outputting the write pulse signal during other periods.

Therefore, the reference value can be varied according to the type of the recording medium on which the pulse signal is written, thereby modifying the waveform of the write pulse signal more appropriately.

Further, in the write correction circuit of the present invention, the pulse modification circuit includes a space/mark counter for detecting the count values of space sections and mark sections of the write pulse signal, and outputting the detected count values; a reference value holding circuit for holding, as a reference value, a value longer than a length that is previously set as the section length of the write pulse signal; a comparator for comparing the count value outputted from the space/mark counter with the reference value to detect a period in which the count value becomes equal to or larger than the selected reference value; an inversion circuit for inverting the write pulse signal; and a selection circuit for receiving the write pulse signal and an inverted signal that is outputted from the inversion circuit, and selecting and outputting the inverted signal during the period in which the count value is equal to or larger than the reference value, which period is detected by the comparator, while selecting and outputting the write pulse signal during other periods.

Therefore, a pattern (section) which is longer than the length that is previously set as the section length of the pulse signal, and is unacceptable as an input, can be removed from the inputted write pulse signal.

Further, a write correction method of the present invention comprises a pulse modification step of modifying the lengths of space sections and mark sections in a write pulse signal used for recording information on a recording medium, which lengths are outside a range that is previously set as a section length of the write pulse signal; a space/mark length detection circuit of detecting the space length and the mark length of the write pulse signal, which are modified in the pulse modification step; an address generation/timing control step of performing address generation and timing control for recording information on the recording medium, on the basis of the outputs of the space length and the mark length detected in the space/mark length detection step; a multiple phase signal output step of generating multiple phase signals by shifting the phase of an input clock signal, and outputting the multiple phase signals; and a timing generation step of generating a write correction signal on the basis of the output of the address generation/timing control step and the output of the multiple phase signal output step, and outputting the write correction signal.

Therefore, in the write pulse signal inputted to a write correction circuit, a portion having a length outside the range that is previously set as the section length is modified, and thereafter, write correction is performed to the modified pulse signal. As a result, highly precise write correction can be performed.

Further, in the write correction method of the present invention, the pulse modification step modifies, in the write pulse signal, a space section equal to or smaller than a reference value which is shorter than the length that is previously set as the section length of the write pulse signal, to a mark section, and modifies a mark section equal to or smaller than the reference value to a space section.

Therefore, the mark sections and space sections having the section lengths shorter than the reference value can be removed from the write pulse signal, and consequently, more precise write correction can be carried out.

Further, in the write correction method of the present invention, the pulse modification step modifies, in the write pulse signal, a mark section next to a space section equal to or smaller than a reference value which is shorter than the length that is previously set as the section length of the write pulse signal, to a space section, and modifies a space section next to a mark section equal to or smaller than the reference value to a mark section.

Therefore, the mark sections and space sections having the section lengths shorter than the reference value can be removed from the write pulse signal, and consequently, more precise write correction can be carried out.

Further, in the write correction method of the present invention, the pulse correction step modifies, in the write pulse signal, a mark section next to a space section equal to or smaller than a reference value which is shorter than the length that is previously set as the section length of the write pulse signal, to a space section, and modifies a space section next to a mark section equal to or smaller than the reference value to a mark section, and when the lengths of the mark section and the space section after the modification are equal to or longer than a predetermined length, the pulse correction step restricts the space section of the portion equal to or longer than the predetermined length to a mark section, and restricts the mark section of the portion equal to or longer than the predetermined length to a space section.

Therefore, when modifying the write pulse signal by extending the patterns (sections) which are included in the write pulse signal and have the section lengths shorter than the reference value, the modification can be carried out so that the patterns (sections) having the lengths longer than the length that is previously set as the section length of the pulse signal are not included in the modified write pulse signal. As a result, more precise write correction can be carried out.

Further, in the write correction method of the present invention, a plurality of reference values have previously been set for each combination of section lengths of continuous plural space sections or mark sections of the write pulse signal; and the pulse modification circuit modifies, in the write pulse signal, a space section that is equal to or smaller than a reference value which is selected according to the combination of the section lengths of the plural space sections or mark sections, to a mark section, and modifies a mark section equal to or smaller than the selected reference value to a space section.

Therefore, the reference value can be selected according to the plural section lengths of the write pulse signal, and consequently, the write pulse signal can be modified more appropriately.

Further, in the write correction method of the present invention, a plurality of reference values have previously been set for plural kinds of recording media on which the write pulse signal is to be written, respectively; and the pulse modification circuit modifies, in the write pulse signal, a space section that is equal to or smaller than a reference value which is selected according to the recording medium on which the write pulse signal is written, to a mark section, and modifies a mark section equal to or smaller than the selected reference value to a space section.

Therefore, the reference value can be varied according to the type of the recording medium on which the pulse signal is written, whereby the waveform of the write pulse signal can be modified more appropriately.

Further, in the write correction method of the present invention, a plurality of reference values have previously been set for plural kinds of recording modes for writing the write pulse signal on a recording medium, respectively; and the pulse modification circuit modifies, in the write pulse signal, a space section that is equal to or smaller than a reference value which is selected according to the recording mode of the write pulse signal, to a mark section, and modifies a mark section equal to or smaller than the selected reference value to a space section.

Therefore, the reference value can be varied according to the type of the write mode for writing the pulse signal on the recording medium, whereby the waveform of the write pulse signal can be modified more appropriately.

Further, in the write correction method of the present invention, the pulse modification step modifies, in the write pulse signal, a space section equal to or larger than a reference value which is a value longer than the length that is previously set as the section length of the write pulse signal, to a mark section, and modifies a mark section equal to or larger than the reference value to a space section.

Therefore, a pattern (section) which is longer than the length that is previously set as the section length of the pulse signal, and is unacceptable as an input, can be removed from the inputted write pulse signal.

### EFFECTS OF THE INVENTION

According to the write correction circuit and the write correction method of the present invention, the write correction circuit is provided with the pulse modification circuit for modifying a pulse signal used for recording information in a recording medium, and before performing write correction, the pulse modification circuit performs modification to remove too-short or too-long space sections and mark sections having the lengths outside the range that is previously set as a section length of the pulse signal, and then the modified write pulse signal is subjected to write correction. Therefore, highly precise write correction can be performed for the write pulse signal.

Furthermore, according to the write correction circuit and the write correction method of the present invention, a space section and a mark section to be targets of modification in the pulse modification circuit are determined on the basis of a reference value that is previously set according to the count values of continuous plural sections in the pulse signal, or on the basis of a reference value that is previously set according to the recording medium on which the pulse signal is written, or the writing mode. Therefore, more appropriate modification can be performed for the write pulse signal, and consequently, more precise write correction can be carried out.

### BRIEF DESCRIPTION OF THE DRAWINGS

FIG. 1 is a diagram illustrating the construction of a write correction circuit according to a first embodiment of the present invention.

FIG. 2 is a diagram illustrating the construction of a pulse modification circuit included in the write correction circuit according to the first embodiment of the present invention.

FIG. 3 is a diagram illustrating the construction of a space/mark counter included in the pulse modification circuit according to the first embodiment of the present invention.

FIG. 4 is a diagram illustrating signal waveforms outputted from the respective parts of the pulse modification circuit according to the first embodiment.

FIG. 5 is a diagram illustrating the construction of a write correction circuit according to a second embodiment.

FIG. 6 is a diagram illustrating the construction of a pulse modification circuit included in the write correction circuit according to the second embodiment of the present invention.

FIG. 7 is a diagram illustrating a space/mark counter included in the pulse modification circuit according to the second embodiment of the present invention.

FIG. 8 is a diagram illustrating signal waveforms outputted from the respective parts of the pulse modification circuit according to the second embodiment.

FIG. 9 is a diagram illustrating the construction of a write correction circuit according to a third embodiment of the present invention.

FIG. 10 is a diagram illustrating a pulse modification circuit included in the write correction circuit according to the third embodiment of the present invention.

FIG. 11 is a diagram illustrating the construction of a signal control circuit included in the pulse modification circuit according to the third embodiment of the present invention.

FIG. 12 is a diagram illustrating signal waveforms outputted from the respective parts of the pulse modification circuit according to the third embodiment of the present invention.

FIG. 13 is a diagram illustrating the construction of a write correction circuit according to a fourth embodiment of the present invention.

FIG. 14 is a diagram illustrating the construction of a pulse modification circuit included in the write correction circuit according to the fourth embodiment of the present invention.

FIG. 15 is a diagram illustrating the construction of a space/mark counter included in the pulse modification circuit according to the fourth embodiment of the present invention.

FIG. 16 is a diagram illustrating signal waveforms outputted from the respective parts of the pulse modification circuit according to the fourth embodiment of the present invention.

FIG. 17 is a diagram illustrating the construction of a write correction circuit according to a fifth embodiment of the present invention.

FIG. 18 is a diagram illustrating a pulse modification circuit included in the write correction circuit according to the fifth embodiment of the present invention.

FIG. 19 is a diagram illustrating the construction of a space/mark counter included in the pulse modification circuit according to the fifth embodiment of the present invention.

FIG. 20 is a diagram illustrating signal waveforms outputted from the respective parts of the pulse modification circuit according to the fifth embodiment of the present invention.

FIG. 21 is a diagram illustrating the construction of a write correction circuit according to a sixth embodiment of the present invention.

FIG. 22 is a diagram illustrating a pulse modification circuit included in the write correction circuit according to the sixth embodiment of the present invention.

FIG. 23 is a diagram illustrating another construction of a pulse modification circuit included in the write correction circuit according to the sixth embodiment of the present invention.

FIG. 24 is a diagram illustrating the construction of a write correction circuit according to a seventh embodiment of the present invention.

FIG. 25 is a diagram illustrating the construction of a pulse modification circuit included in the write correction circuit according to the seventh embodiment of the present invention.

FIG. 26 is a diagram illustrating signal waveforms outputted from the respective parts of the pulse modification circuit according to the seventh embodiment of the present invention.

FIG. 27 is a diagram illustrating the construction of a write signal processing system included in the conventional information recording apparatus.

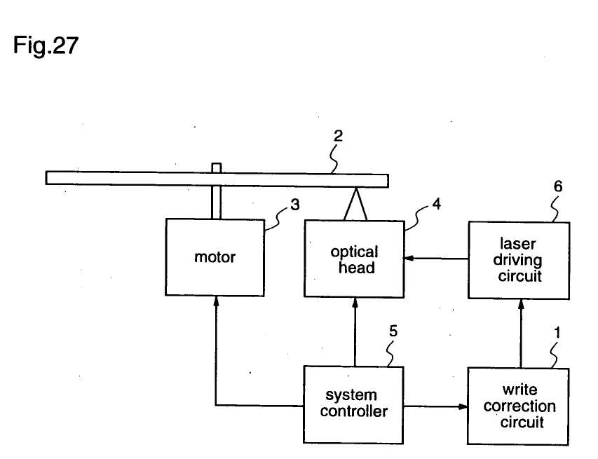

FIG. 28 is a diagram illustrating the construction of a write correction circuit included in the conventional information recording apparatus.

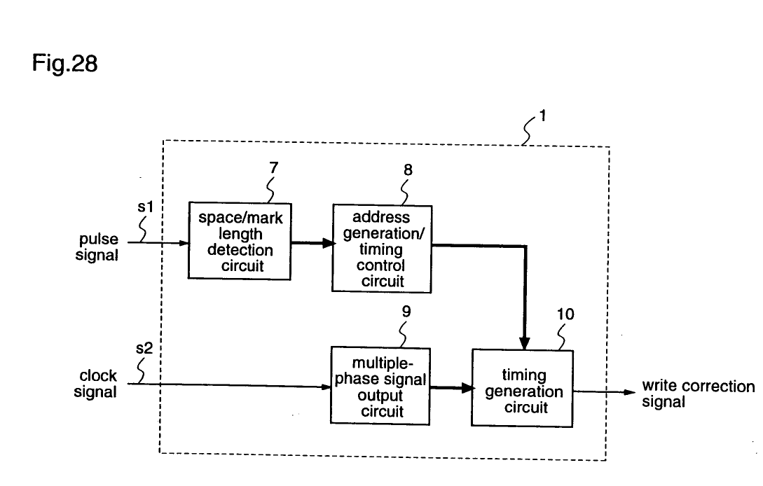

### DESCRIPTION OF REFERENCE NUMERALS

1,100,200,300,400,500,600,700 . . . write correction circuit
2 . . . optical disc
3 . . . motor
4 . . . optical head
5 . . . system controller
6 . . . laser driving circuit
7 . . . space/mark length detection circuit
8 . . . address generation/timing control circuit
9 . . . multiple-phase signal output circuit
10 . . . timing generation circuit
11,21,31,41,51,61,61′,71 . . . pulse modification circuit
12,22,42,52 . . . space/mark counter
13 . . . comparator
14 . . . selection circuit
15 . . . output delay circuit
16,56 . . . reference value holding circuit
32 . . . period control circuit
44 . . . second selection circuit
62 . . . media basis reference value holding circuit
63 . . . mode basis reference value holding circuit
72 . . . inversion circuit
121,221,421,521 . . . edge detector
122,222,422,522 . . . space counter
123,223,423,523 . . . mark counter
124,224,424,524 . . . switching circuit
225,425 . . . section delay circuit
321 . . . second counter
323 . . . second comparator
324 . . . second reference value holding circuit
426 . . . count value selection circuit
525 . . . first section delay circuit
526 . . . second section delay circuit

### BEST MODE TO EXECUTE THE INVENTION

Hereinafter, embodiments of the present invention will be described with reference to the drawings.

### Embodiment 1

In the first embodiment of the present invention, a pulse modification circuit is provided in the input stage of the conventional write correction circuit, and the pulse modification circuit performs, for a binarized recording information waveform (pulse signal) to be recorded on a recording medium, modification so as to remove a mark section and a space section which are included in the pulse signal and have the lengths outside a range that is previously set as a section length of the pulse signal, thereby removing the sections having the lengths outside the set range from the pulse signal, resulting in highly precise write correction.

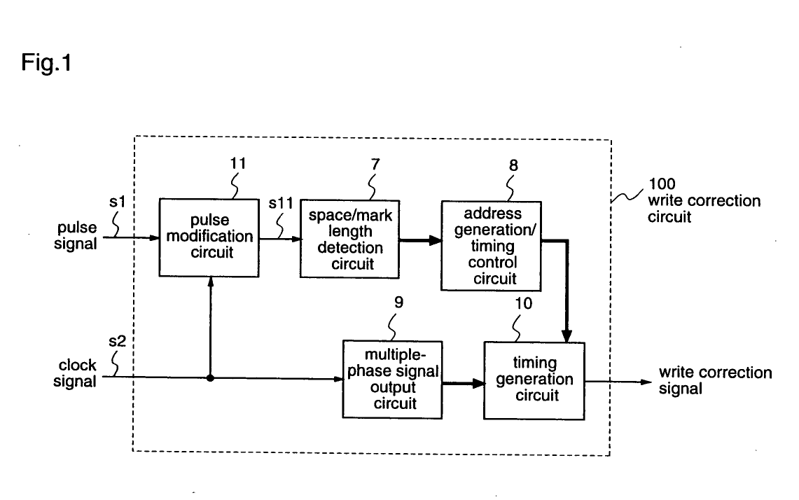

Hereinafter, a write correction circuit 100 according to the first embodiment of the present invention will be described with reference to FIGS. 1 to 4. FIG. 1 is a block diagram illustrating the construction of the write correction circuit according to the first embodiment. With reference to FIG. 1, the write correction circuit 100 is obtained by providing the conventional structure shown in the FIG. 1 with a pulse modification circuit 11 for modifying a pulse signal s1 inputted to the write correction circuit 100 to output a modified pulse signal s11.

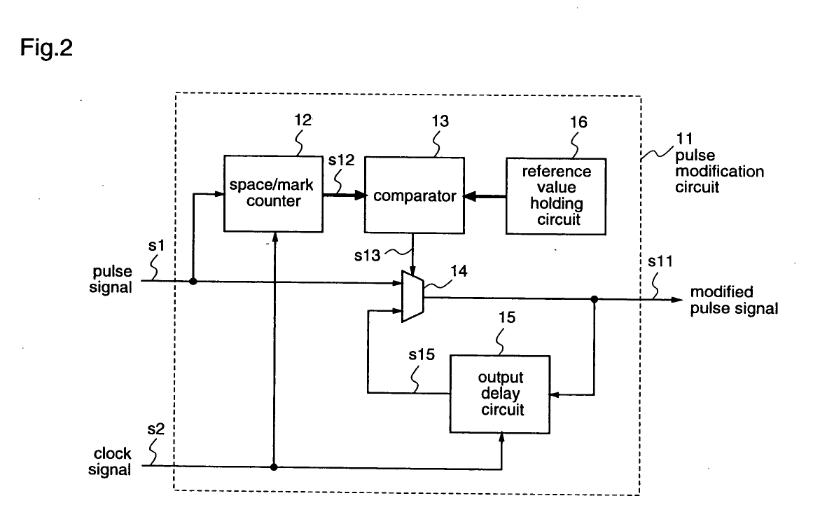

FIG. 2 is a block diagram illustrating the construction of the pulse modification circuit in the write correction circuit 100 shown in FIG. 1. With reference to FIG. 2, the pulse modification circuit 11 includes a space/mark counter 12 for detecting the count values of space sections and mark sections of the pulse signal s1, and switchingly outputting the values, a reference value holding circuit 16 for holding a reference value to be compared with the count values of the space sections and the mark sections that are counted by the space/mark counter 12, a comparator 13 for comparing an output s12 from the space/mark counter 12 with the reference value held by the reference value holding circuit 16 to detect a period in which the output of the space/mark counter 12 is equal to or lower than the reference value, an output delay circuit 15 for delaying an output from a selection circuit 14 described later on the basis of a clock signal s2, and outputting the delayed signal, and a selection circuit 14 for selecting either the pulse signal s1 or a signal s15 outputted from the output delay circuit 15 on the basis of a signal s13 outputted from the comparator 13, and outputting the selected signal.

In the reference value holding circuit 16, a value outside the range that is previously set as a section length of the pulse signal s1 is set as a reference value, and a too-short pattern section (e.g., a section having a length of only “1T” or “2T”) and a too-long pattern (e.g., a section having a length of “12T” or more), which patterns are unacceptable as an input pulse signal, are removed from the pulse signal s1. The first embodiment will be described for the case where a value shorter than the length that is previously set as a section length of the write pulse signal, i.e., the length of the too-short section, is set as a reference value.

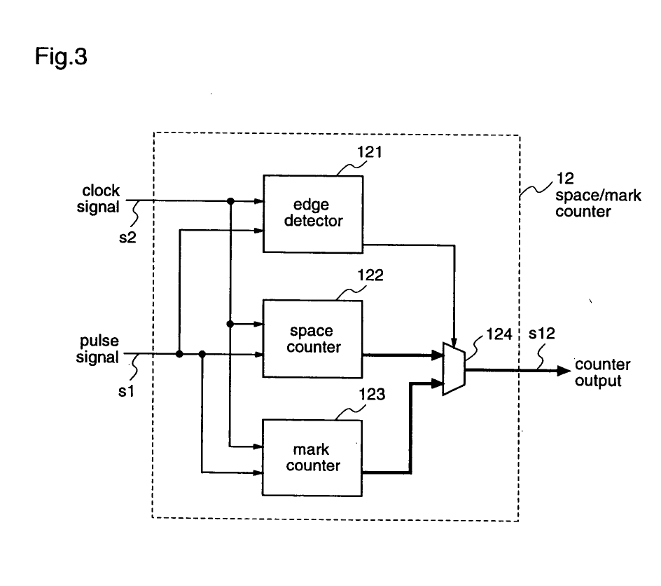

FIG. 3 is a block diagram illustrating a specific construction of the space/mark counter included in the pulse modification circuit 11 shown in FIG. 2. In FIG. 3, the space/mark counter 12 includes an edge detector 121 for detecting a rising edge or a falling edge of the input pulse signal s1 to detect an end position of a space section (a start position of a mark section) or an end position of a mark section (a start position of a space section), a spacer counter 122 for counting the space section of the pulse signal s1, a mark counter 123 for counting the mark section of the pulse signal s1, and a switching circuit 124 for switchingly outputting the count value of the mark counter 123 and the count value of the space counter 122 on the basis of the output from the edge detector 121.

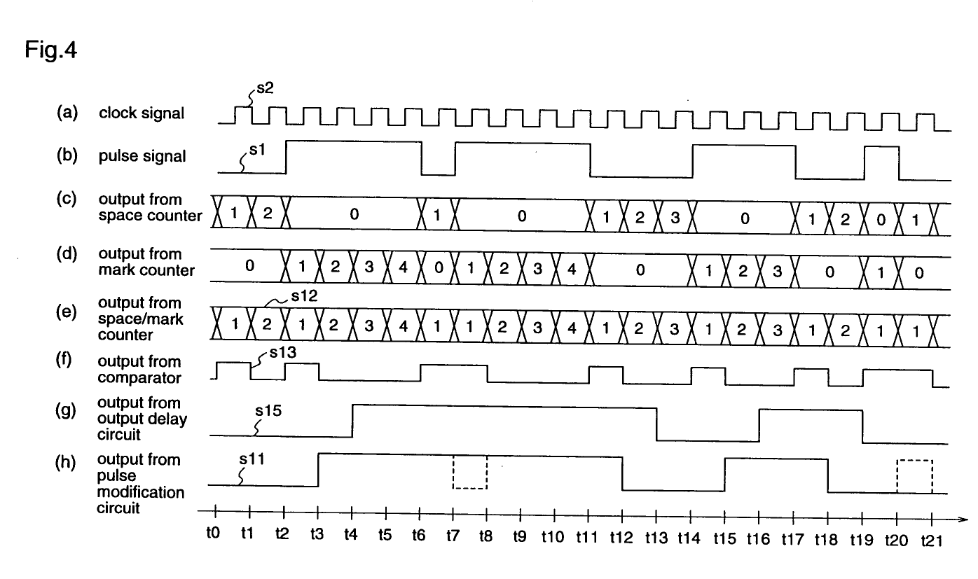

Next, the operation of the write correction circuit 100 of the first embodiment will be described with reference to FIG. 4. FIG. 4 is a timing chart of the pulse modification circuit in the write correction circuit according to the first embodiment.

The pulse signal s1 shown in FIG. 4(b) which is inputted to the write correction circuit 100 is initially inputted to the pulse modification circuit 11. In the pulse modification circuit 11, the count values of the space sections and the mark sections of the pulse signal s1 are detected by the space/mark counter 12. To be specific, the edge detector 121 detects a rising edge or a falling edge of the pulse signal s1, and the switching circuit 124 switchingly outputs the count value of the space counter 122 and the count value of the mark counter 123 on the basis of the output from the edge detector 121 (refer to FIGS. 4(c)˜(e)).

Then, the comparator 13 compares the output s12 from the space/mark counter 12 shown in FIG. 4(e) with the reference value set in the reference value holding circuit 16 to detect a period in which the output s12 from the space/mark counter 12 becomes equal to or lower than the reference value. For example, assuming that the reference value held in the reference value holding circuit 16 is “1T”, the comparator 13 outputs the control signal s13 which is “H” level during the period where the output s12 from the space/mark counter 12 is equal to or smaller than “1T”, and is “L” level during other periods, as shown in FIG. 4(f).

Thereafter, the selection circuit 14 selects either the input pulse signal s1 (FIG. 4(b)) or the signal s15 from the output delay circuit 15 (FIG. 4(g)) on the basis of the control signal s13 from the comparator 13, and outputs the selected signal as a modified pulse signal s11 (FIG. 4(h)). In this first embodiment, the pulse signal S1 is outputted when the control signal s13 outputted from the comparator 13 is “L” level, while the output s15 from the output delay circuit 15 is outputted when the control signal s13 is “H” level.

As a result of the above-mentioned operation, the too-short space section equal to or shorter than the reference value (“1T”) becomes a mark section while the too-short mark section becomes a space section, which sections are included in the pulse signal s1 (FIG. 4(b)) inputted to the write correction circuit 100, whereby the too-short sections (patterns) in the pulse signal s1 are removed as shown in FIG. 4(h), resulting in a modified pulse signal s11 including no too-short sections.

Thereafter, the modified pulse signal s11 is inputted to the space/mark length detector 7 of the write correction circuit 100, and write correction identical to the conventional one is carried out using the modified pulse signal s11. Since this operation is identical to the conventional one, repeated description is not necessary.

As described above, according to the first embodiment, in the pulse modification circuit 11 provided in the input stage of the write correction circuit 100, the pulse signal s1 inputted to the write correction circuit 100 is modified so as to remove the too-short space sections and too-short mark sections in the pulse signal s1, which are unacceptable as sections in a pulse signal, and thereafter, write correction is carried out using the modified pulse signal s11. Therefore, highly precise write correction can be carried out to the pulse signal s1 inputted to the write correction circuit 100.

Further, according to the first embodiment, in the pulse modification circuit 11, a too-short section length that is unacceptable as a section length of the input pulse signal s1 is set as a reference value, the respective count values of the mark sections and the space sections in the pulse signal s1 are detected, each count value is compared with the reference value, and the pulse signal s1 is outputted when the count value is larger than the reference value, while not the pulse signal s1 but the signal s15 that is outputted from the pulse modification circuit 11 at an immediately previous clock timing is outputted when the count value is equal to or smaller than the reference value. Therefore, it is possible to remove the space section and the mark section that are equal to or smaller than the reference value from the pulse signal s1 by modifying the space section equal to or smaller than the reference value and the mark section equal to or smaller than the reference value, which are included in the pulse signal s1, to a mark section and to a space section, respectively, whereby the too-short patterns (sections) in the pulse signal s1, which are unacceptable as inputs, can be removed.

### Embodiment 2

In a second embodiment of the present invention, a pulse modification circuit is provided in the input stage of the write correction circuit, and the pulse correction circuit modifies an inputted pulse signal so as to extend a space section and a mark section which are included in the pulse signal and have the lengths outside a range that is previously set as a section length of the pulse signal, whereby the sections included in the pulse signal and having the lengths outside the set range in the pulse signal are removed.

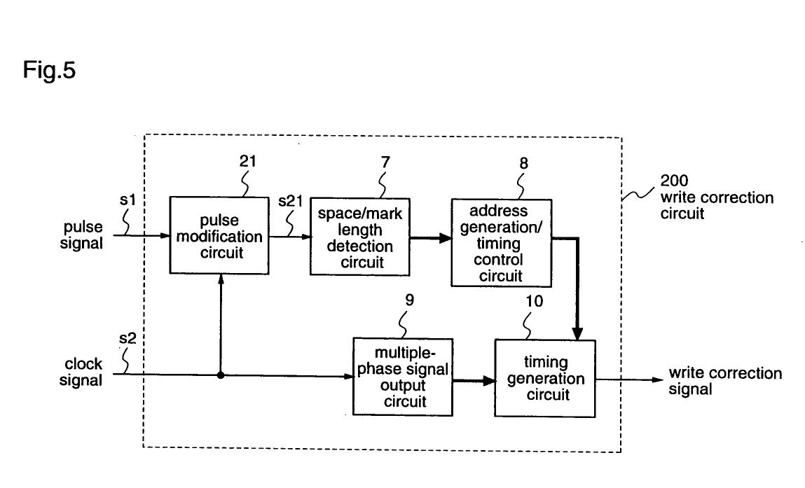

Hereinafter, a write correction circuit 200 according to the second embodiment will be described with reference to FIGS. 5 to 8.

As shown in FIG. 5, the write correction circuit 200 of the second embodiment is provided with, in the input stage thereof, a pulse modification circuit 21 which modifies a pulse signal s1 inputted to the write correction circuit 200 to output a modified pulse signal s21, like the write correction circuit 100 of the first embodiment.

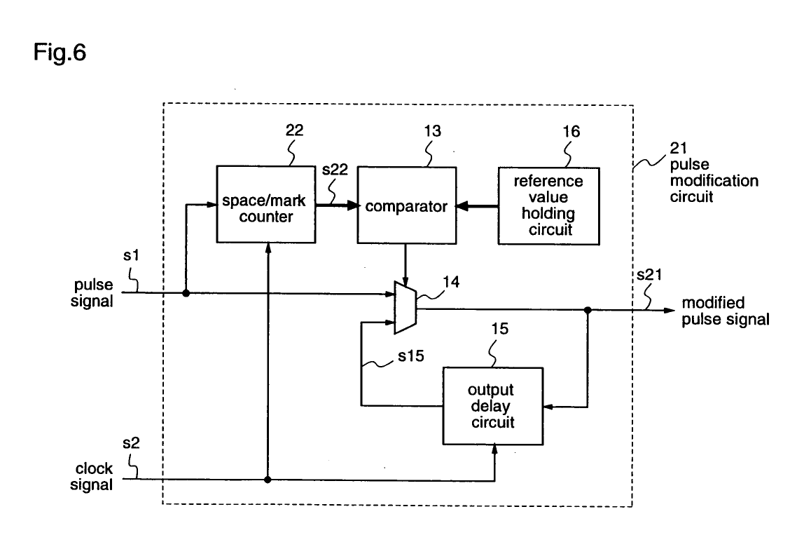

FIG. 6 is a block diagram illustrating the construction of the pulse modification circuit 21 included in the write correction circuit 200 according to the second embodiment. In FIG. 6, the pulse correction circuit 21 includes a space/mark counter 22 for detecting the count values of space sections and mark sections of the pulse signal s1, and switchingly outputting these values, a reference value holding circuit 16 for holding a reference value to be compared with the count values of the space sections and the mark sections that are counted by the space/mark counter 22, a comparator 13 for comparing an output s22 from the space/mark counter 12 with the reference value held in the reference value holding circuit 16 to detect a period in which the output of the space/mark counter 22 becomes equal to or smaller than the reference value, an output delay circuit 15 for delaying an output s21 from a selection circuit described later on the basis of a clock signal s2, and outputting the delayed signal, and a selection circuit 14 for selecting either the inputted pulse signal s1 or a signal s15 outputted from the output delay circuit 15 on the basis of a control signal s13 outputted from the comparator 13. In the reference value holding circuit 16, a value shorter than the length that is previously set as a section length of the write pulse signal, i.e., a too-short length (e.g., “1T” or “2T”), is set as a reference value, as in the first embodiment.

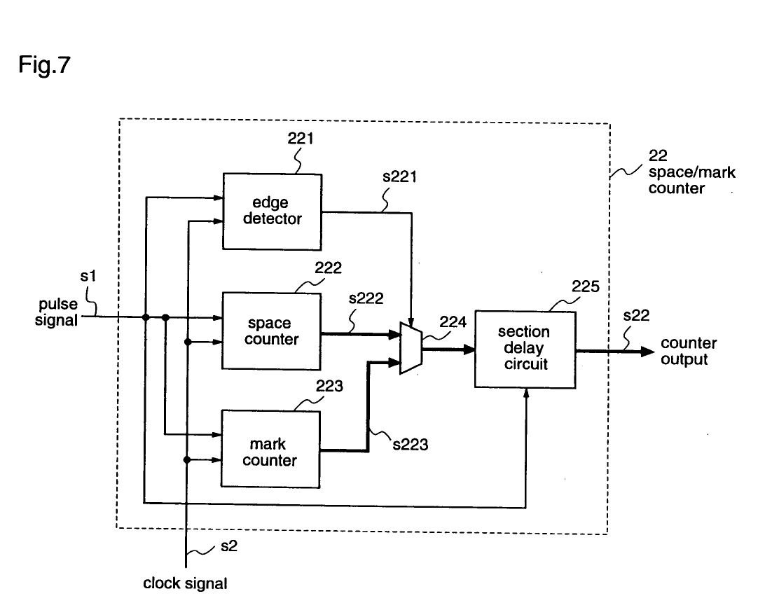

FIG. 7 is a block diagram illustrating the specific construction of the space/mark counter 22 included in the pulse modification circuit 21 shown in FIG. 6. In FIG. 7, the space/mark counter 22 includes an edge detector 221 for detecting a rising edge or a falling edge of the input pulse signal s1 to detect an end position of a space section (a start position of a mark section) or an end position of a mark section (a start position of a space section), a spacer counter 222 for counting the space section of the pulse signal s1, a mark counter 223 for counting the mark section of the input pulse signal s1, a switching circuit 224 for switchingly outputting a count value s223 of the mark counter 223 and a count value s222 of the space counter 222 on the basis of an output s221 from the edge detector 221, and a section delay circuit 225 for outputting the count value of a mark section or a space section that is immediately previous to the count value s224 outputted from the switching circuit 224, on the basis of the both edges (rising edge and falling edge) of the pulse signal s1. Therefore, as for the output s22 from the space/mark counter 22, the count value of the mark section or the space section which is immediately previous to the count value of the space section or the mark section that is outputted from the switching circuit 224 is continuously outputted while the pulse signal s1 rises or falls.

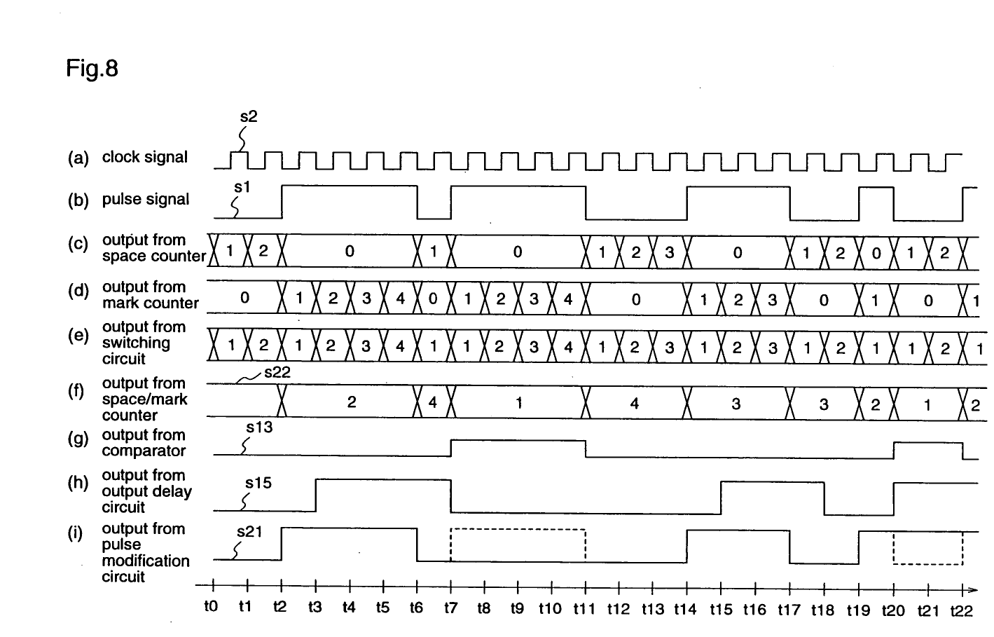

Next, the operation of the write correction circuit 200 according to the second embodiment will be described with reference to FIG. 8. FIG. 8 is a timing chart of the pulse modification circuit included in the write correction circuit according to the second embodiment.

The pulse signal s1 shown in FIG. 8(b) which is supplied to the write correction circuit 200 is initially inputted to the pulse modification circuit 21. In the pulse modification circuit 21, the space/mark counter 22 detects the count values of the space sections and the mark sections of the pulse signal s1. To be specific, the edge detector 221 detects a rising edge or a falling edge of the pulse signal s1, and the switching circuit 224 switchingly outputs the count value s222 of the space counter 222 and the count value s223 of the mark counter 223 on the basis of the output of the edge detector 221, and further, the section delay circuit 225 delays the count value outputted from the switching circuit 224 on the basis of the both edges (rising edge and falling edge) of the pulse signal s1, thereby outputting the count value of the previous timing (refer to FIGS. 8(c)˜8(f)). That is, as for the output s22 from the space/mark counter 22, the count value of the mark section or the space section which is previous to the count value s224 of the space section or the mark section which is outputted from the switching circuit 224 shown in FIG. 8(e) is continuously outputted as shown in FIG. 8(f).

Then, the comparator 13 compares the output s22 from the space/mark counter 22 as shown in FIG. 8(f) with the reference value set in the reference value holding circuit 16 to detect a period in which the output s22 from the space/mark counter 22 becomes equal to or smaller than the reference value. For example, assuming that the reference value is “1T”, the comparator 13 outputs, as shown in FIG. 8(g), a control signal s13 which is “H” level during a period where the output s22 from the space/mark counter 22 is not larger than “1”, and is “L” level during other periods.

Thereafter, the selection circuit 14 selects either the inputted pulse signal s1 (FIG. 8(b)) or the signal s15 (FIG. 8(h)) from the output delay circuit 15 that delays the output s21 from the selection circuit 14, on the basis of the control signal s13 from the comparator 13, and outputs the selected signal as a modified pulse signal s21 (FIG. 8(i)). In this second embodiment, the selection circuit 14 outputs the pulse signal s1 when the control signal s13 outputted from the comparator 13 is “L” level, and outputs the output s15 of the output delay circuit 15 when the control signal s13 is “H” level.

As the result of the above-described operation, a mark section next to a too-short space section that is included in the pulse signal s1 (FIG. 8(b)) inputted to the write correction circuit 200 and is equal to or smaller than the reference value (“1T”) becomes a mark section, while a space section next to a too-short mark section included in the pulse signal s1 becomes a mark section, whereby the too-short sections (patterns) in the pulse signal s1 are extended as shown in FIG. 8(i), and consequently, a modulated pulse signal s21 including no too-short sections is obtained.

Thereafter, the modulated pulse signal s21 is inputted to the space/mark length detector 7 of the write correction circuit 200, and write correction similar to the conventional one is carried out using the modulated pulse signal s21. Since this operation is identical to that of the prior art, repeated description is not necessary.

As described above, according to the second embodiment, in the pulse modification circuit 21 provided in the input stage of the write correction circuit 200, the pulse signal s1 inputted to the write correction circuit 200 is modified such that the lengths of the too-short space section and too-short mark section included in the pulse signal s1, which are unacceptable as sections in a pulse signal, are extended, and thereafter, write correction is carried out using the modified pulse signal s21, thereby realizing highly precise write correction for the pulse signal s1 that is inputted to the write correction circuit 200.

Further, according to the second embodiment, in the pulse modification circuit 21, a too-short section length that is unacceptable as a section length of the input pulse signal s1 is set as a reference value, the respective count values of the mark sections and the space sections in the pulse signal s1 are detected, the count values are delayed on the basis of the both edges (rising edge and falling edge) of the pulse signal s1, each delayed count value is compared with the reference value, and the pulse signal s1 is outputted when the count value is larger than the reference value while the output s15 from the output delay circuit 15 is outputted when the count value is equal to or smaller than the reference value. Therefore, it is possible to extend the space section and the mark section that are equal to or smaller than the reference value by modifying a space section and a mark section which are next to the space section and the mark section that are included in the pulse signal s1 and are equal to or smaller than the reference value to a space section and to a mark section, respectively, whereby the too-short patterns (sections) in the pulse signal s1, which are unacceptable as inputs, can be removed.

### Embodiment 3

According to a third embodiment of the present invention, when the pulse modification circuit performs modification to an input pulse signal so as to extend a space section and a mark section having lengths outside a range that is previously set as a section length of the pulse signal, the lengths of the modified space section and mark section are limited so as to be equal or smaller than a predetermined section length.

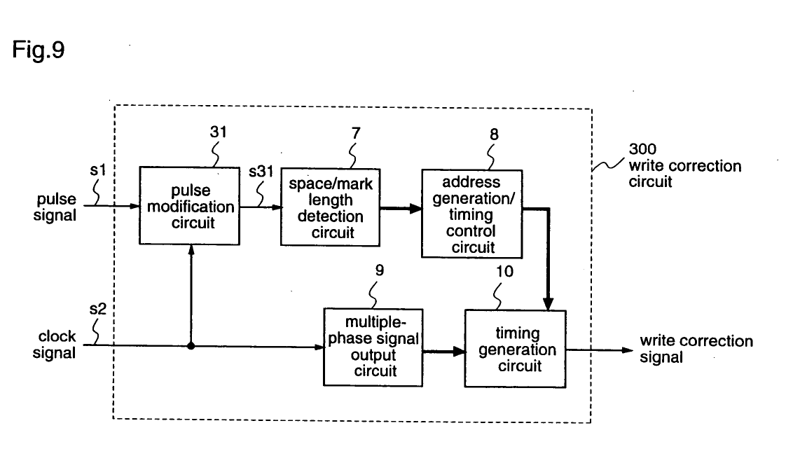

Hereinafter, a write correction circuit 300 according to the third embodiment will be described with reference to FIGS. 9 to 11.

As shown in FIG. 9, the write correction circuit 300 according to the third embodiment is provided with, in its input stage, a pulse modification circuit 31 which modifies a pulse signal s1 inputted to the write correction circuit 300 to output a modified pulse signal s31, like the write correction circuit 100 according to the first embodiment.

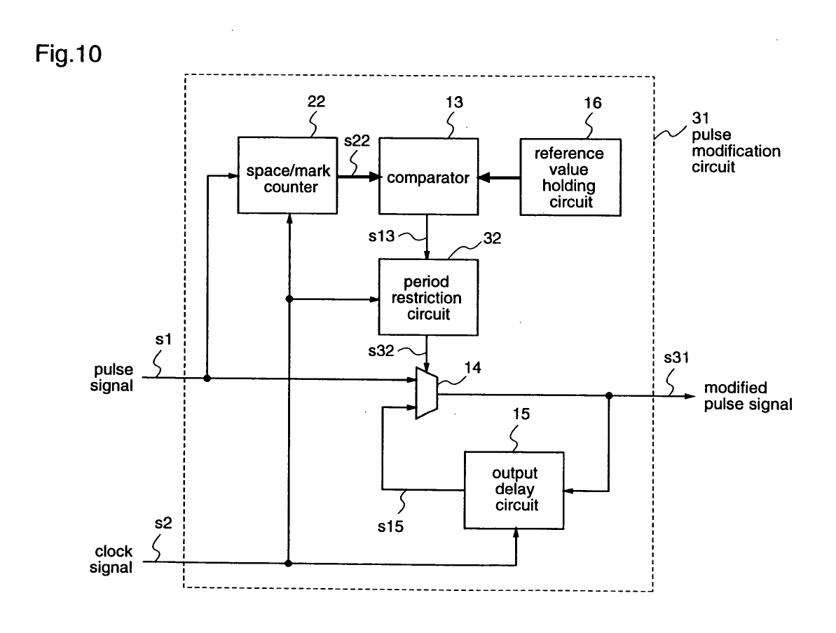

FIG. 10 is a block diagram illustrating the pulse correction circuit 31 included in the write correction circuit 300 according to the third embodiment. With reference to FIG. 10, the pulse correction circuit 31 includes a space/mark counter 22 for detecting the count values of space sections and mark sections of the pulse signal s1, and switchingly outputting these values, a reference value holding circuit 16 for holding a first reference value to be compared with the count values of the space sections and the mark sections that are counted by the space/mark counter 22, a comparator 13 for comparing an output s22 from the space/mark counter 12 with the first reference value that is held in the reference value holding circuit 16 to detect a period during which the output of the space/mark counter 22 becomes equal to or smaller than the first reference value, a period restriction circuit 32 for generating a second control signal s32 from a control signal s13 outputted from the comparator 13, an output delay circuit 15 for delaying an output s31 from a selection circuit described later on the basis of the clock signal s2, and outputting the delayed signal, and a selection circuit 14 for selecting either the inputted pulse signal s1 or a signal s15 outputted from the output delay circuit 15 on the basis of the second control signal s32 outputted from the period restriction circuit 32. Since the construction of the space/mark counter 22 included in the pulse modification circuit 31 is identical to that of the second embodiment, repeated description is not necessary. Further, in the reference value holding circuit 16, a value shorter than the length that is previously set as a section length of the write pulse signal, i.e., a too-short length (e.g., “1T” or “2T”) is set as a reference value, like in the first embodiment.

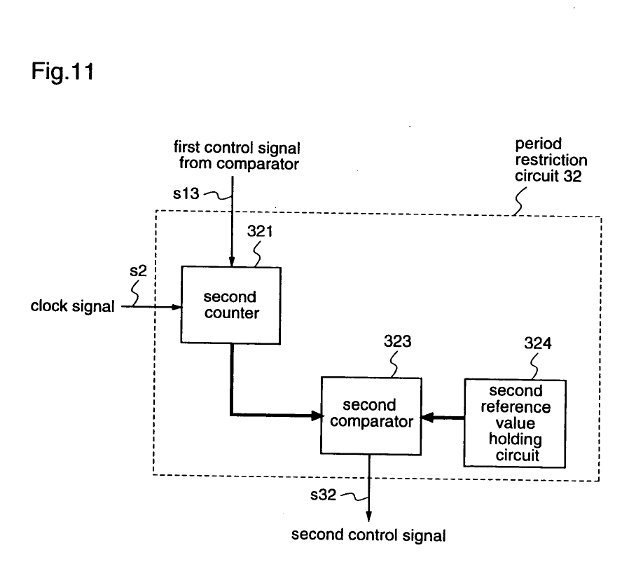

FIG. 11 is a block diagram illustrating the specific construction of the period restriction circuit 32 included in the pulse modification circuit 31 shown in FIG. 10. In FIG. 11, the period restriction circuit 32 includes a second counter 321 for counting the “H” level section (period to be extended) of the first control signal s13 that is outputted from the comparator 13 and controls the selection circuit 14, on the basis of the clock signal s2, a second reference value holding circuit 324 for holding a second reference value to be compared with the output value of the second counter 321, and a second comparator 323 for restricting the “H” level period detected by the second counter 321 so as to be equal to or lower than the second reference value.

As described above, since the third embodiment is provided with the period restriction circuit 32 for restricting the period detected by the comparator 13 within a predetermined period, when the “H” level section of the first control signal s13 outputted from the comparator 13 is longer than the predetermined second reference value, the period restriction circuit 32 restricts the length of the “H” level section to the length of the second reference value. Thereby, when modification for extending the mark section and the space section in the pulse signal s1, which are shorter than the first reference value, is carried out, it is possible to prevent a too-long section having a length outside the range that is previously set as a section length of the pulse signal from occurring in the pulse signal s31 after the modification.

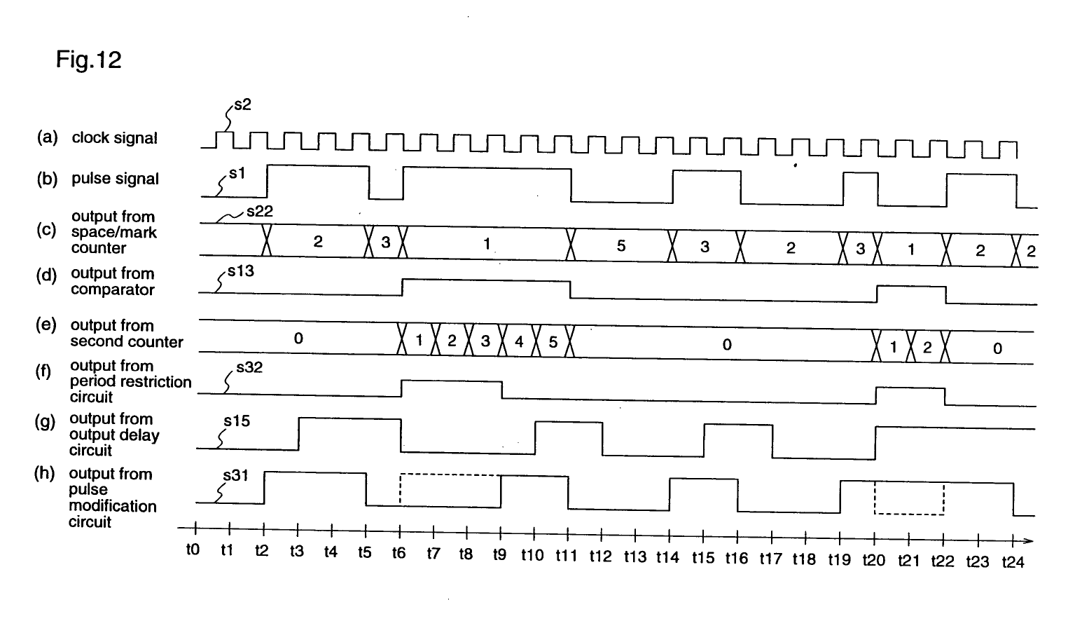

Next, the operation of the write correction circuit 300 according to the third embodiment will be described with reference to FIG. 12. FIG. 12 is a timing chart of the pulse modification circuit included in the write correction circuit according to the second embodiment.

The pulse signal s1 shown in FIG. 12(b) supplied to the write correction circuit 300 is initially inputted to the pulse modification circuit 31. In the pulse modification circuit 31, the space/mark counter 22 detects the count values of space sections and mark sections in the pulse signal s1 (refer to FIG. 12(c)). Since the operation of the space/mark counter 22 is identical to that of the second embodiment, repeated description is not necessary.

Then, the comparator 13 compares the output s22 from the space/mark counter 22 shown in FIG. 12(c) with the first reference value that is previously set in the reference value holding circuit 16 to detect a period during which the output s22 from the space/mark counter 22 is equal to or smaller than the first reference value. For example, assuming that the reference value is “1T”, the comparator 13 outputs a control signal s13 which is “H” level during a period where the output s22 from the space/mark counter 22 is not larger than “1”, and is “L” level during other periods, as shown in FIG. 12(d).

The output s13 from the comparator 13 is inputted to the period restriction circuit 32. In the period restriction circuit 32, the second counter 321 detects the count value of the “H” level section (FIG. 12(e)), and thereafter, the second comparator 323 compares the predetermined second reference value with the count value detected by the second counter 321. When the output from the second counter 321 is larger than the second reference value, the second comparator 323 outputs the second control signal s32 in which the “H” level section length of the first control signal s13, which is detected by the second counter 321, is replaced with the second reference value. On the other hand, when the output from the second counter 321 is smaller than the second reference value, the second comparator 323 outputs the first control signal s13 that is detected by the second counter 321, as the second control signal s32.

For example, assuming that the second reference value is “3T”, when the “H” level section of the output s13 from the comparator 13 is longer than “3T”, the period restriction circuit 32 outputs the second control signal s32 in which the “H” level section is changed from “5T” to “3T” as shown in FIG. 12(f). On the other hand, when the “H” level section of the output S13 from the comparator 13 is equal to or smaller than “3T”, the period restriction circuit 32 outputs the first control signal s13 outputted from the comparator 13, as the second control signal s32.

Thereafter, the selection circuit 14 selects either the inputted pulse signal s1 (FIG. 12(b)) or the signal s15 (FIG. 12(g)) from the output delay circuit 15 that delays the output s21 from the selection circuit 14, on the basis of the second control signal s32 from the period restriction circuit 32, and outputs the selected signal as a modified pulse signal s31 (FIG. 12(h)). For example, the pulse signal s1 is outputted when the second control signal s32 outputted from the period restriction circuit 32 is “L”, and the signal s15 from the output delay circuit 15 is outputted when the second control signal s32 is “H”.

As the result of the above-described operation, the pulse signal s1 (FIG. 12(b)) inputted to the write correction circuit 300 is modified so that a mark section next to a too-short space section that is included in the pulse signal s1 and is equal to or smaller than the first reference value (“1T”) is changed to a mark section while a space section next to a too-short mark section is changed to a mark section, thereby to extend the too-short sections, thereby obtaining a modified pulse signal s31 which does not include too-long space sections and too-long mark section having lengths outside the range that is previously been set as a section length of the pulse signal.

Thereafter, the modulated pulse signal s31 is inputted to the space/mark length detector 7 in the write correction circuit 300, and write correction similar to that described for the prior art is carried out using the modulated pulse signal s31. Since this operation is identical to that of the prior art, repeated description is not necessary.

As described above, according to the third embodiment, in the pulse modification circuit 31 that is provided in the input stage of the write correction circuit 300, the pulse signal s1 inputted to the write correction circuit 300 is modified such that the lengths of the too-short space section and too-short mark section included in the pulse signal s1, which are unacceptable as sections in a pulse signal, are extended to be restricted within a predetermined range, and thereafter, write correction is carried out using the modified pulse signal s31, thereby realizing more precise write correction for the pulse signal s1 inputted to the write correction circuit 300.

Further, according to the third embodiment, when the periods of the mark section and the space section in the pulse section, which are extended by the pulse modification circuit 31, are longer than the predetermined second reference value, the extended periods of the mark section and the space section in the pulse signal are replaced with the period indicated by the second reference value. Therefore, the too-short patterns (sections) included in the pulse signal s1, which are unacceptable as inputs in the pulse signal s1, can be modified to appropriate pattern lengths (section length).

### Embodiment 4

According to a fourth embodiment of the present invention, a pulse modification circuit is provided in an input stage of a write correction circuit, and when the pulse modification circuit modifies an input pulse signal so that space sections and mark sections having lengths outside a range that is previously set as a section length of the pulse signal are not included in the inputted pulse signal, it is selected with a selection signal as to whether the modification should be performed by removing the sections having the lengths outside the set range as in the first embodiment or by extending the sections having the lengths outside the set range as in the second embodiment.

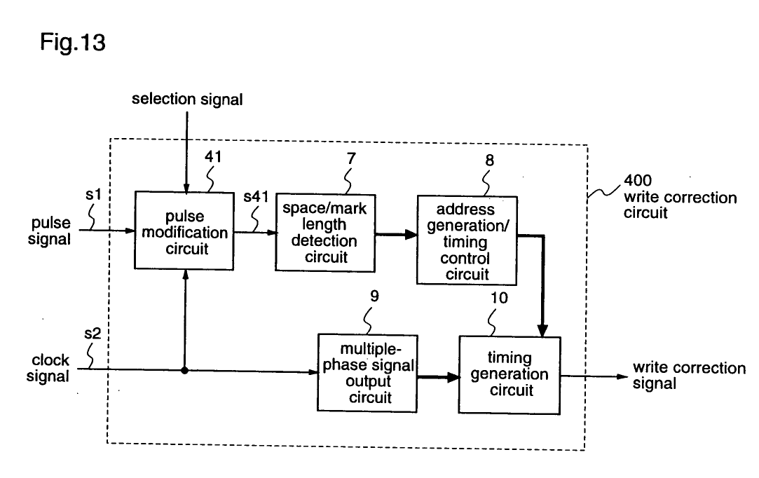

Hereinafter, a write correction circuit 400 according to the fourth embodiment will be described with reference to FIGS. 13 to 16.

As shown in FIG. 13, the write correction circuit 400 according to the fourth embodiment is provided with, in its input stage, a pulse modification circuit 41 which modifies an input pulse signal s1 inputted to the write correction circuit 400 on the basis of a selection signal externally inputted to the write correction circuit 400, and outputs a modified pulse signal s41.

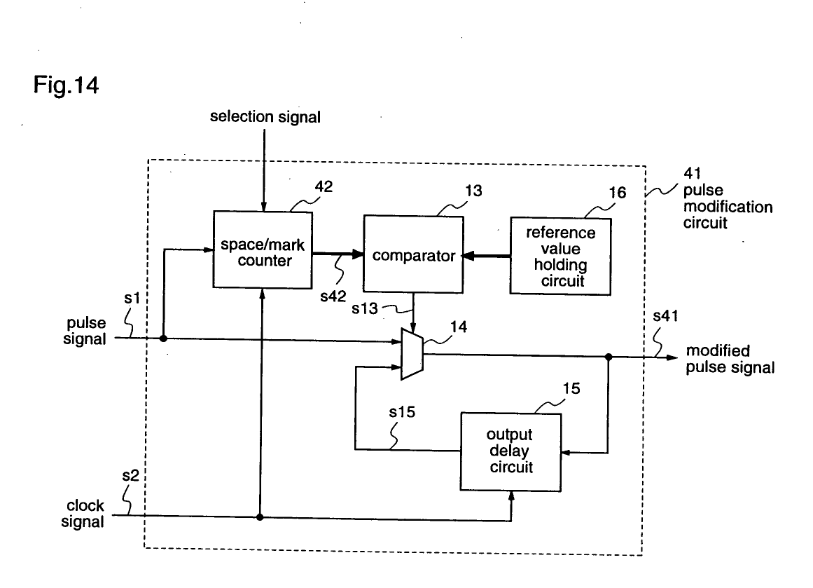

FIG. 14 is a block diagram illustrating the construction of the pulse modification circuit 41 included in the write correction circuit 400 according to the fourth embodiment. In FIG. 14, the pulse correction circuit 41 includes a space/mark counter 42 for detecting the count values of space sections and mark sections in the pulse signal s1, respectively, and outputting these values, a reference value holding circuit 16 for holding a reference value to be compared with the count values of the space sections and the mark sections that are counted by the space/mark counter 42, a comparator 13 for comparing an output s42 from the space/mark counter 42 with the reference value held in the reference value holding circuit 16 to detect a period in which the output of the space/mark counter 42 becomes equal to or lower than the reference value, an output delay circuit 15 for delaying an output s41 from a selection circuit described later on the basis of a clock signal s2, and outputting the delayed signal, and a selection circuit 14 for selecting either the inputted pulse signal s1 or the signal s15 outputted from the output delay circuit 15 on the basis of a control signal s13 outputted from the comparator 13. In the reference value holding circuit 16, a value shorter than the length that is previously set as a section length of the write pulse signal, i.e., a too-short length (e.g., “1T” or “2T”) is set as a reference value, as in the first embodiment.

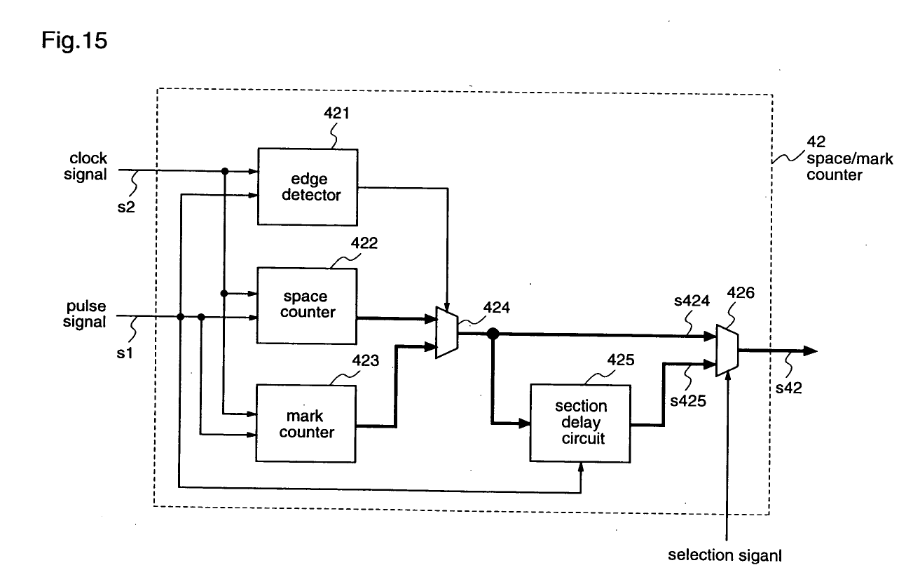

FIG. 15 is a block diagram illustrating the specific construction of the space/mark counter 42 included in the pulse modification circuit 41 shown in FIG. 14. In FIG. 15, the space/mark counter 42 includes an edge detector 421 for detecting a rising edge or a falling edge of the input pulse signal s1 to detect an end position of a space section (start position of a mark section) or an end position of a mark section (a start position of a space section), a spacer counter 422 for counting the space sections of the pulse signal s1, a mark counter 423 for counting the mark sections of the pulse signal s1, a switching circuit 424 for switchingly outputting the count value of the mark counter 423 and the count value of the space counter 422 on the basis of the output from the edge detector 421, a section delay circuit 4 for delaying the output s424 (hereinafter referred to as “first count value”) from the switching circuit 424 on the basis of the both edges (rising edge and falling edge) of the pulse signal s1, and outputting a count value s425 (hereinafter referred to as “second count value”) that is outputted from the switching circuit 424 at a timing previous to the first count value, and a count value selection circuit 426 for selecting the first and second count values s424 and s425 on the basis of an externally inputted selection signal.

The first count value s424 is a count value outputted from the switching circuit 424, like the count value s12 obtained in the first embodiment, and the second count value s425 is a count value of a mark section or a space section that is previous to the space section or the mark section indicated by the count value s424 outputted from the switching circuit 424, like the count value s22 obtained in the second embodiment.

Accordingly, in this fourth embodiment, as a method for removing too-short sections included in the pulse signal s1, it is possible to select one of the modification method of removing the too-short sections which is described for the first embodiment, and the method of extending the too-short sections which is described for the second embodiment.

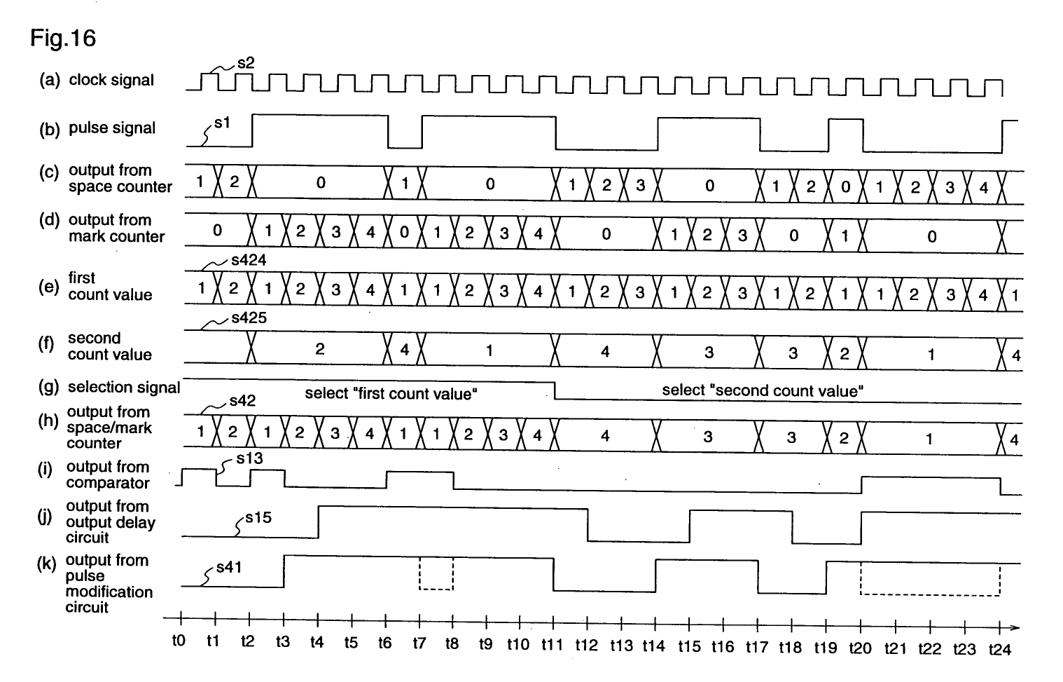

Next, the operation of the write correction circuit 400 according to the fourth embodiment will be described with reference to FIG. 16. FIG. 16 is a timing chart of the pulse modification circuit in the write correction circuit 400 according to the fourth embodiment.

The pulse signal s1 shown in FIG. 16(b) which is supplied to the write correction circuit 400 is initially inputted to the pulse modification circuit 41. In the pulse modification circuit 41, the space/mark counter 42 detects count values of space sections and mark sections in the pulse signal s1. In the space/mark counter 42 of the fourth embodiment, the above-mentioned first and second count values are detected, and one of the count values which is selected by the counter value selection circuit on the basis of the selection signal is outputted. It is assumed that the first count value s424 is selected when the selection signal is “H” level, while the second count value s425 is selected when the selection signal is “L” level (refer to FIG. 16(h)).

Then, the comparator 13 compares the count value s42 selected by the count value selection circuit 426 with the reference value that is previously set in the reference value holding circuit 16 to detect a period during which the count value s42 becomes equal to or smaller than the reference value. For example, assuming that the reference value is “1T”, the comparator 13 outputs a control signal s13 which is “H” level during a period where the output s42 from the space/mark counter 42 is not larger than “1”, and is “L” level during other periods, as shown in FIG. 16(i).

Thereafter, in the selection circuit 14, either the inputted pulse signal s1 (FIG. 16(b)) or the signal s15 (FIG. 16(j)) outputted from the output delay circuit 15 that delays the output s41 of the selection circuit 14 is selected according to the control signal s13 outputted from the comparator 13, and the selected signal is outputted as a modified pulse signal s41 (FIG. 16(k)). For example, the pulse signal s1 is outputted when the control signal s13 outputted from the comparator 13 is “L” level, while the signal s15 from the output delay circuit 15 is outputted when the control signal s13 is “H” level.

As the result of the above-mentioned operation, modification for removing the too-short space sections or mark sections which are included in the pulse signal s1 (FIG. 16(b)) inputted to the write correction circuit 400 and are equal to or smaller than the reference value (“1T”), is carried out by the method based on the selection signal, thereby obtaining a modified pulse signal s41 including no too-short patterns (sections).

Thereafter, the modified pulse signal s41 is inputted to the space/mark length detector 7 of the write correction circuit 400, and write correction similar to the prior art is carried out using the modified pulse signal s41. Since this operation is identical to the prior art, repeated description is not necessary.

As described above, according to the fourth embodiment, in the pulse modification circuit 41 provided in the input stage of the write correction circuit 400, after the input pulse signal s1 is subjected to modification based on the externally inputted selection signal, write correction is carried out using the modified pulse signal s41. Therefore, more appropriate pulse modification can be performed to the pulse signal s1 inputted to the write correction circuit 400, thereby realizing more precise write correction.

Further, according to the fourth embodiment, when the pulse modification circuit 41 performs modification for removing too-short mark sections or space sections that are equal to or smaller than the reference value from the pulse signal s1, it is selected as to whether the too-short mark sections or space sections are to be removed or extended, whereby the too-short patterns (sections) in the pulse signal can be modified more appropriately.

While in this fourth embodiment selection of the count value to be outputted from the space/mark counter 42 is changed according to the selection signal during processing, it may be previously determined as to which method should be selected, and thereby selection of the count value is not changed during processing.

### Embodiment 5

In the above-mentioned embodiments, the lengths of the space sections and mark sections in the write pulse signal are compared with one reference value that is stored in the reference value holding circuit. In this fifth embodiment, however, a plurality of reference values are previously set for each combination of the section lengths of continuous plural space sections and mark sections in the write pulse signal, and a reference value is selected according to the combination of the section lengths of the plural space sections or mark sections.

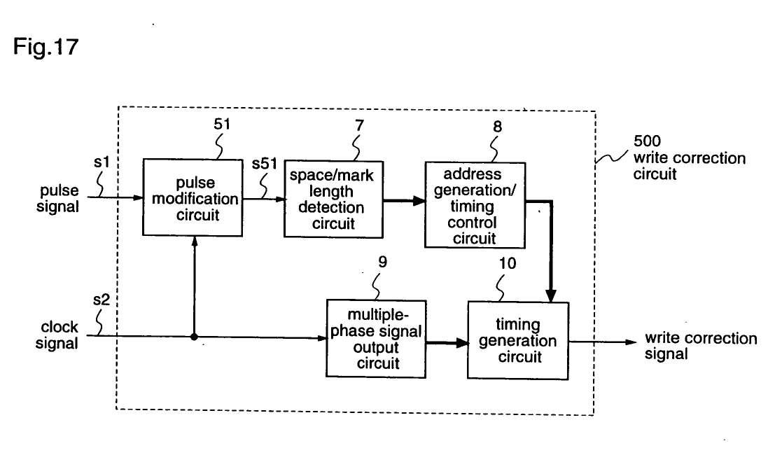

Hereinafter, the write correction circuit 500 according to the fifth embodiment will be described with reference to FIGS. 17 to 20.

As shown in FIG. 17, the write correction circuit 500 according to the fifth embodiment is provided with, in its input stage, a pulse modification circuit 51 which modifies the pulse signal s1 inputted to the write correction circuit 500, and outputs a modified pulse signal s51.

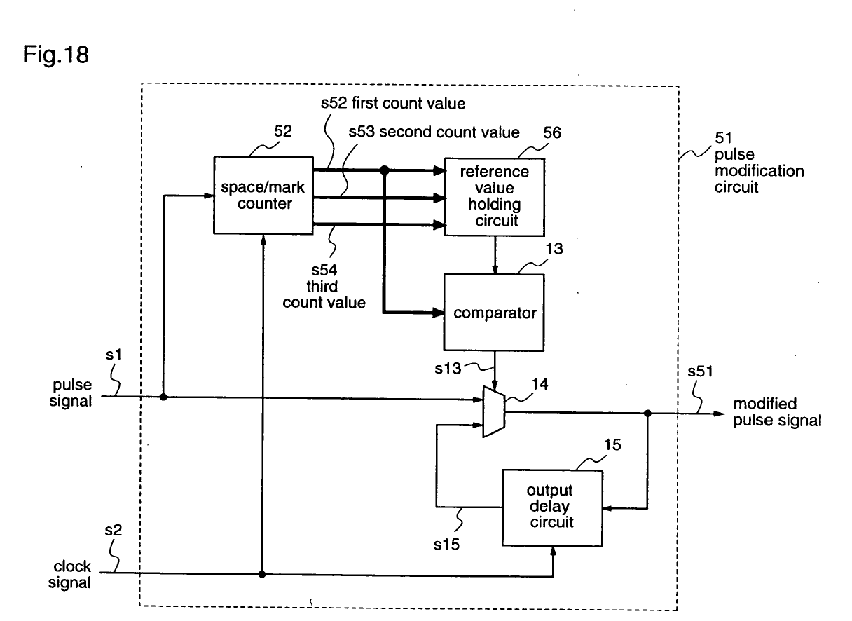

FIG. 18 is a block diagram illustrating the construction of the pulse modification circuit 51 in the write correction circuit 500 according to the fifth embodiment. In FIG. 8, the pulse modification circuit 51 includes a space/mark counter 52 for detecting the count values of space sections and mark sections in the pulse signal s1, respectively, and outputting the count values of the continuous sections as the first to third count values s52˜s54, a reference value holding circuit 56 for holding predetermined plural reference values that are set for each combination of the continuous three count values s52˜s54 outputted from the space/mark counter 52, a comparator 13 for comparing the reference value held in the reference value holding circuit 56 with the first count value s52 outputted from the space/mark counter 52 to detect a period in which the output of the space/mark counter 52 becomes equal to or smaller than the reference value, an output delay circuit 15 for delaying the output s51 from a selection circuit described later on the basis of a clock signal s2, and outputting the delayed signal, and a selection circuit 14 for selecting either the inputted pulse signal s1 or the signal s15 outputted from the output delay circuit 15 on the basis of a control signal s13 outputted from the comparator 13.

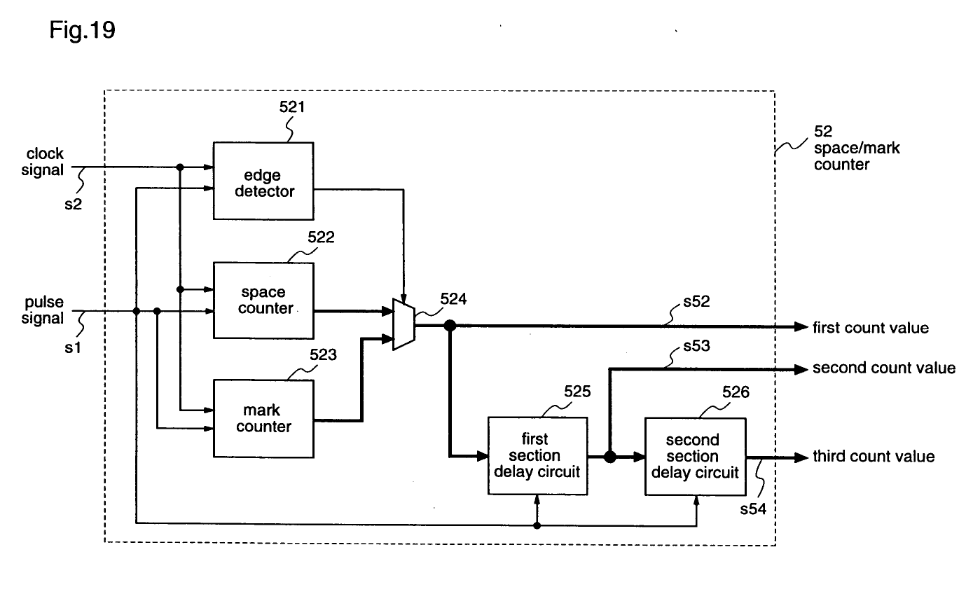

FIG. 19 is a block diagram illustrating the specific construction of the space/mark counter 52 in the pulse modification circuit 51 shown in FIG. 18. In FIG. 19, the space/mark counter 52 includes an edge detector 521 for detecting a rising edge or a falling edge of the input pulse signal s1 to detect an end position of a space section (start position of a mark section) or an end position of a mark section (a start position of a space section), a spacer counter 522 for counting the space sections of the pulse signal s1, a mark counter 523 for counting the mark sections of the pulse signal s1, a switching circuit 524 for switchingly outputting the count value of the mark counter 523 and the count value of the space counter 522 on the basis of the output from the edge detector 521, a first section delay circuit 525 for delaying the output of the switching circuit 524 on the basis of the both edges (rising edge and falling edge) of the pulse signal s1, and a second section delay circuit 526 for delaying the first section delay circuit 525 on the basis of the both edges of the pulse signal s1. Thereby, the first count value s52 is outputted from the switching circuit 524, the second count value s53 is outputted from the first section delay circuit 525, and the third count value s54 is outputted from the second section delay circuit 523, and therefore, the space/mark counter 52 can output the count values of continuous three sections, i.e., “space, mark, space” or “mark, space, mark”.

In the reference value holding circuit 56, reference values are previously set for each combination of the three values of the first to third count values s52˜s54, whereby a more appropriate reference value according to the three count values s52˜s54 outputted from the space/mark counter 52 can be selected.

The reference value holding circuit 56 can be implemented by a table or the like, wherein three reference values that one-to-one correspond to the combination of the three count values are held, or two or less reference values that multiple-to-one correspond to the combination of the three count values.

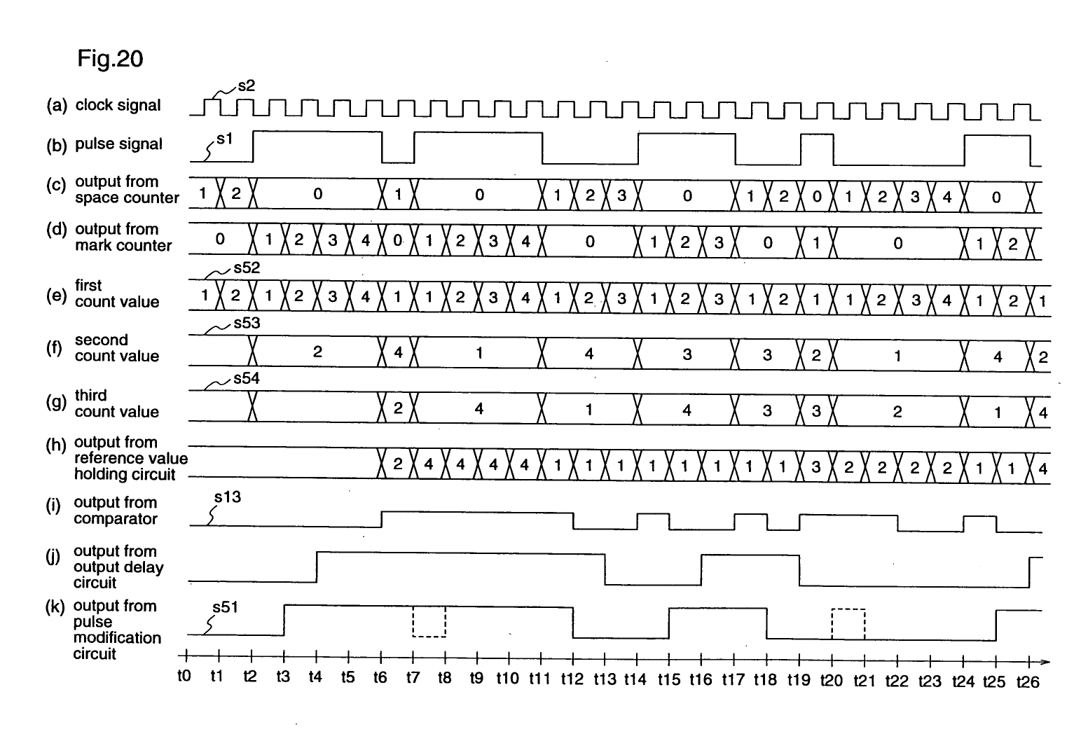

Next, the operation of the write correction circuit 500 according to the fifth embodiment will be described with reference to FIG. 20. FIG. 20 is a diagram illustrating waveforms of signals outputted from the respective parts of the pulse modification circuit 51 in the write correction circuit of the fifth embodiment.

The pulse signal s1 shown in FIG. 20(b) which is supplied to the write correction circuit 500 is initially inputted to the pulse modification circuit 51. In the pulse modification circuit 51, space sections and mark sections of the pulse signal s1 are detected and outputted by the space/mark counter 52 (refer to FIGS. 20(c)˜20(g)). In this fifth embodiment, the above-described three counter values s52˜s54 are outputted from the space/mark counter 52.

The three count values s52˜s54 outputted from the space/mark counter 52 are inputted to the reference value holding circuit 56, and a reference value according to the three values is selected as shown in FIG. 20(h).

Then, in the comparator 13, the reference value selected according to the three count values is compared with the first counter value s52 outputted from the space/mark counter 52 to detect a period in which the first count value s52 becomes equal to or lower than the reference value (refer to FIG. 20(i)).

Thereafter, the selection circuit 14 selects either the inputted pulse signal s1 (FIG. 20(b)) or the signal s15 (FIG. 20(j)) outputted from the output delay circuit 15 on the basis of the control signal s13 outputted from the comparator 13, and outputs the selected signal as a modified pulse signal s51 (refer to FIG. 20(k)). For example, the pulse signal s1 is outputted when the control signal s13 outputted from the comparator 13 is “L” level, while the output s15 from the output delay circuit 15 is outputted when the control signal s13 is “H” level.

As the result of the above-mentioned operation, the too-short mark sections and space sections included in the pulse signal s1 (FIG. 20(b)) inputted to the write correction circuit 500 are detected on the basis of the reference values according to the count values of the continuous three sections in the pulse signal, and then the detected sections are removed. As a result, more appropriately modified pulse signal s51 can be obtained.

Thereafter, the modified pulse signal s51 is inputted to the space/mark length detection unit 7 of the write correction circuit 500, and write correction similar to that of the prior art is carried out using the modified pulse signal s51. Since this operation is identical to that of the prior art, repeated description is not necessary.

As described above, according to the fifth embodiment, in the pulse modification circuit 51 provided in the input stage of the write correction circuit 500, after the input pulse signal s1 is modified, write correction is carried out using the modified pulse signal s51. Therefore, it is possible to perform highly precise write correction to the pulse signal s1 inputted to the write correction circuit 500.

Further, according to the fifth embodiment of the invention, the pulse modification circuit 51 detects the count values of continuous three sections from the pulse signal s1, and a reference value is selected according to the three count values. Therefore, too-short patterns (sections) to be modified, which are included in the pulse signal s1, can be determined on the basis of the count values of the continuous sections in the pulse signal s1, whereby more appropriate modification can be carried out to the pulse signal s1, resulting in more precise write correction.

While in this fifth embodiment the space/mark counter 52 detects the lengths of the continuous three sections, the present invention is not restricted thereto. For example, the mark/spacer counter 52 may detect the lengths of continuous plural sections, and the reference value holding unit 56 may previously hold plural reference values corresponding to each combination of the detected section lengths. In this case, since a reference value is selected according to the combination of the plural section lengths, a more appropriate reference value can be selected.

### Embodiment 6

While in the fifth embodiment a reference value is selected according to a combination of the section lengths of continuous plural space sections and mark sections in the write pulse signal, in this sixth embodiment a reference value is selected according to the type of the recording medium in which the write pulse signal is written, or the type of the write mode adopted when writing the pulse signal in the recording medium.

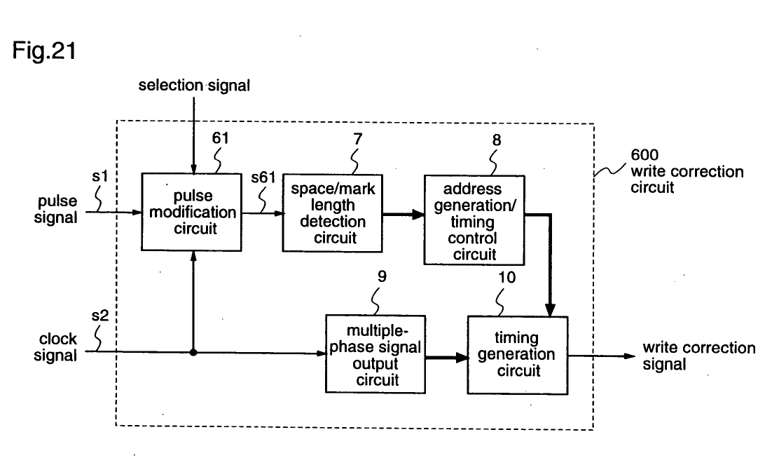

Hereinafter, a write correction circuit 600 according to the sixth embodiment will be described with reference to FIGS. 21˜22.

As shown in FIG. 21, the write correction circuit 600 according to the sixth embodiment is provided with, in its input stage, a pulse modification circuit 61 which modifies a pulse signal s1 inputted to the write correction circuit 600, and outputs a modified pulse signal s61.

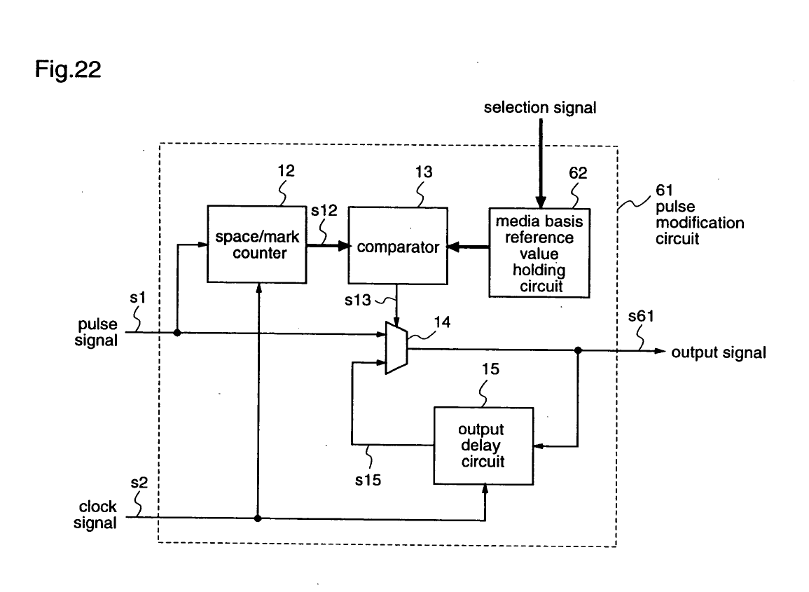

FIG. 22 is a block diagram illustrating the construction of the pulse modification circuit 61 included in the write correction circuit 600 according to the sixth embodiment. In FIG. 22, the pulse correction circuit 61 includes a space/mark counter 12 for detecting the count values of space sections and mark sections of the pulse signal s1, respectively, and outputting these values, a media basis reference value holding circuit 62 for holding plural reference values that are predetermined for different types of media on which the pulse signal is recorded, a comparator 13 for comparing an output s12 from the space/mark counter 12 with the reference value that is selected on the basis of a selection signal by the media basis reference value holding circuit 62 to detect a period in which the output of the space/mark counter 12 becomes equal to or lower than the selected reference value, an output delay circuit 15 for delaying an output s61 from a selection circuit 14 described later on the basis of a clock signal s2, and outputting the delayed signal, and a selection circuit 14 for selecting either the inputted pulse signal s1 or the signal s15 outputted from the output delay circuit 15 on the basis of a control signal s13 outputted from the comparator 13. In this sixth embodiment, the space/mark counter 12 has the same construction as that of the first embodiment.

Next, the operation of the write correction circuit 600 according to the sixth embodiment will be described.

Initially, a signal for selecting a recording medium is externally inputted to the media basis reference value holding circuit 62 in the pulse modification circuit 61, and a reference value to be compared with each section length of the inputted pulse signal s1 is previously selected.

When the pulse signal s1 is supplied to the write correction circuit 600, the pulse signal s1 is initially inputted to the pulse modification circuit 61. In the pulse modification circuit 61, count values of space sections and mark sections in the pulse signal s1 are detected by the space/mark counter 12, and these count values are switchingly outputted.

Then, in the comparator 13, the output s12 from the space/mark counter 12 is compared with the reference value selected by the selection signal to detect a period in which the output s12 from the space/mark counter 12 becomes equal to or smaller than the selected reference value. For example, assuming that the selected reference value is “1T”, the comparator 13 outputs the control signal s13 which is “H” level during the period where the output s12 from the space/mark counter 12 is equal to or smaller than “1T”, and is “L” level during other periods.

Thereafter, in the selection circuit 14, either the inputted pulse signal s1 or the signal s15 outputted from the output delay circuit 15 is selected according to the control signal s13 outputted from the comparator 13, and the selected signal is outputted as a modified pulse signal s61. For example, the pulse signal s1 is outputted when the control signal s13 outputted from the comparator 13 is “L”, while the signal s15 from the output delay circuit 15 is outputted when the control signal s13 is “H”.

As the result of the above-mentioned operation, a reference value according to the recording medium in which the pulse signal s1 inputted to the write correction circuit 600 is written is selected by the selection signal, and mark sections or space sections which are shorter than the selected reference value can be removed, thereby obtaining a pulse signal s61 that is more appropriately modified.

Thereafter, the modified pulse signal s61 is inputted to the space/mark length detection unit 7 in the write correction circuit 600, and write correction similar to that of the prior art is carried out for the modified pulse signal s61. Since this operation is identical to that of the prior art, repeated description is not necessary.

As described above, according to the sixth embodiment, after the input pulse signal s1 is modified by the pulse modification circuit 61 that is provided in the input stage of the write correction circuit 600, write correction is carried out using the modified pulse signal s21. Therefore, highly precise write correction can be performed to the pulse signal s1 inputted to the write correction circuit 200.

Further, according to the sixth embodiment, in the pulse modification circuit 61, since a reference value is selected according to the type of the recording medium on which the pulse signal s1 is written, too-short patterns (sections) to be modified which are included in the pulse signal s1 can be selected on the basis of the recording medium on which the pulse signal s1 is written. Therefore, the waveform of the pulse signal s1 can be modified to a waveform suited to the type of the pulse signal, resulting in more precise write correction.

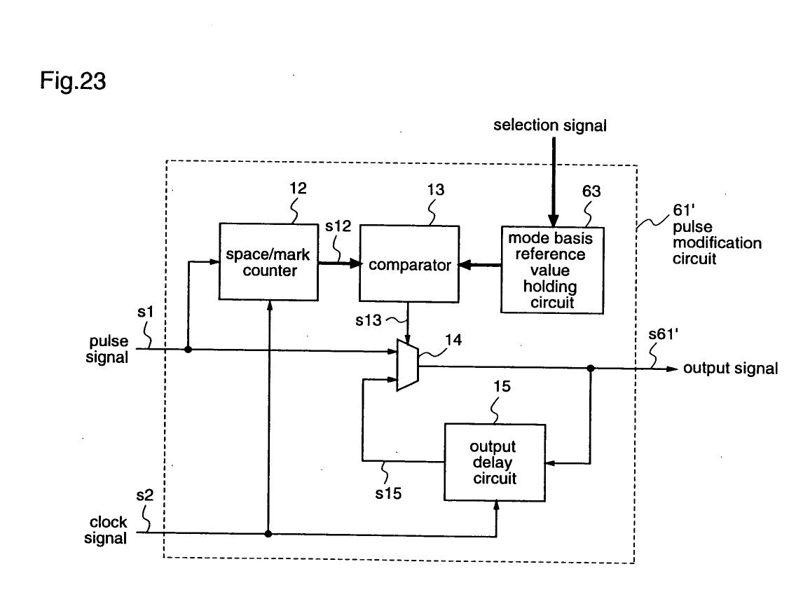

While in this sixth embodiment a reference value is selected according to the type of the recording medium on which the pulse signal s1 is written, since write correction of the write correction circuit supports several types of write modes (write patterns), a write mode basis reference value holding circuit 63 may be provided in the pulse modification circuit 611 as shown in FIG. 23, and a reference value may be selected for each type of write mode for writing the pulse signal s1 on the recording medium, according to an external selection signal.

Furthermore, while in this sixth embodiment the space/mark counter is of the same construction as that of the first embodiment, the present invention is not restricted thereto. For example, the space/mark counter may have the construction of the second or fourth embodiment.

### Embodiment 7

In the respective embodiments mentioned above, when the pulse modification circuit performs modification so that space sections and mark sections having the lengths outside a range that is predetermined as a section length of an inputted pulse signal are not included in the pulse signal, modification for removing the patterns (sections) that are too-short relative to the section length of the pulse signal is carried out. In this seventh embodiment, however, modification for removing the patterns (sections) that are too-long relative to the section length of the pulse signal is carried out.

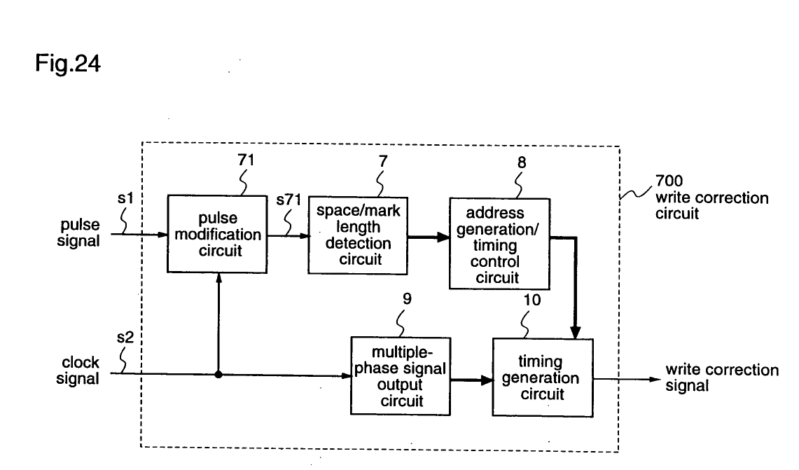

Hereinafter, a write correction circuit 700 according to the seventh embodiment of the present invention will be described with reference to FIGS. 24˜26.

As shown in FIG. 24, the write correction circuit 700 of the seventh embodiment is provided with, in the input stage thereof, a pulse modification circuit 71 which modifies a pulse signal s1 inputted to the write correction circuit 700, and outputs a modified pulse signal s71, like the write correction circuit 100 of the first embodiment.

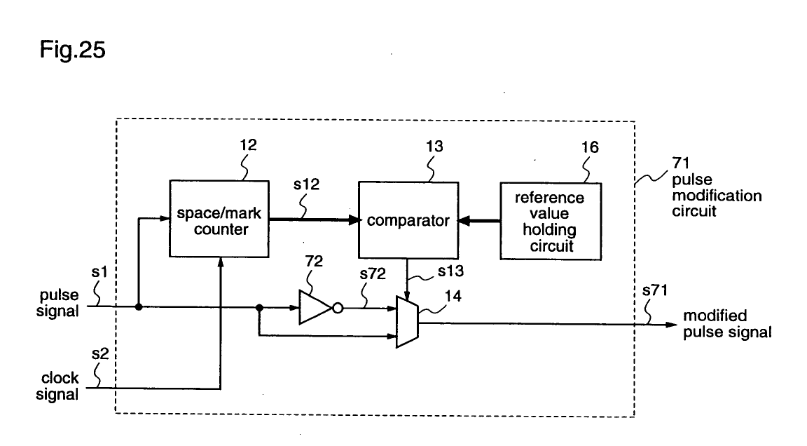

FIG. 25 is a block diagram illustrating the construction of the pulse modification circuit 71 included in the write correction circuit 700 according to the seventh embodiment. In FIG. 25, the pulse correction circuit 71 includes a space/mark counter 12 for detecting the count values of the lengths of space sections and mark sections in the pulse signal s1, and switchingly outputting these values, a reference value holding circuit 16 for holding a reference value to be compared with the count values of the space sections and the mark sections that are counted by the space/mark counter 12, a comparator 13 for comparing an output s12 from the space/mark counter 22 with the reference value held in the reference value holding circuit 16 to detect a period in which the output of the space/mark counter 12 becomes equal to or larger than the reference value, an inversion circuit 72 for inverting the pulse signal s1, and a selection circuit 14 for selecting either the inputted pulse signal s1 or a signal s72 outputted from the inversion circuit 72 on the basis of a control signal s13 outputted from the comparator 13. In this seventh embodiment, the space/mark counter 12 has the same construction as that of the first embodiment.

As described above, usually, the range of the section lengths (space length and mark length) of the sections in the pulse signal S1 depends on the type of the recording medium in which the pulse signal is written, or the type of the write mode for writing the pulse signal in the recording medium.

Accordingly, in the reference value holding circuit 16, a value in a range that is predetermined as a section length of the pulse signal s1 is set as a reference value. In this seventh embodiment, in the reference value holding circuit 16, a value longer than the length that is predetermined as a section length of the write pulse signal, i.e., a too-long section length (for example, 12T or more) is set as a section length of the pulse signal s1.

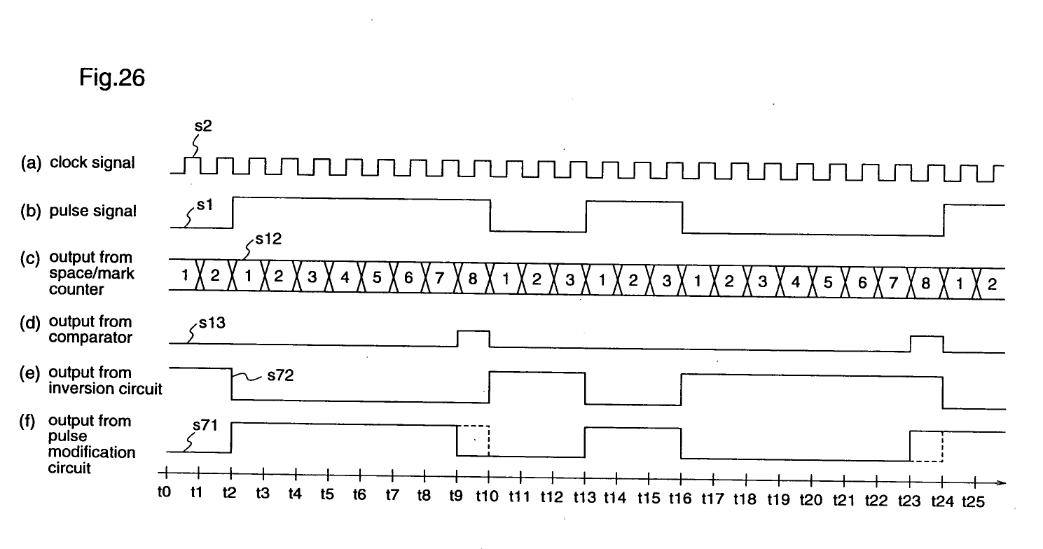

Next, the operation of the write correction circuit 700 according to the seventh embodiment will be described with reference to FIG. 26. FIG. 26 is a diagram illustrating the waveforms of signals outputted from the respective parts of the pulse modification circuit 71 in the write correction circuit.

The pulse signal s1 shown in FIG. 26(b) which is inputted to the write correction circuit 700 is initially inputted to the pulse modification circuit 71. In the pulse modification circuit 71, space sections and mark sections in the inputted pulse signal s1 are detected and outputted by the space/mark counter (refer to FIG. 26(c)).

Then, the comparator 13 compares the output s12 from the space/mark counter 12 as shown in FIG. 26(c) with the reference value that is previously set in the reference value holding circuit 16 to detect a portion in which the output s12 from the space/mark counter 12 is larger than the reference value, and outputs the detection result as a binary signal as shown in FIG. 26(d). For example, assuming that the reference value held in the reference value holding circuit 16 is “7T”, when the output s12 from the space/mark counter 12 is larger than “7”, the comparator 13 raises the edge to make the output s12 “H” level, while the output s12 is “L” level in other cases, as shown in FIG. 26(d).

Thereafter, the selection circuit 14 selects either the inputted pulse signal s1 (FIG. 26(b)) or the output s72 (FIG. 26(e)) from the inversion circuit 72 on the basis of the control signal s13 from the comparator 13, and outputs the selected signal as a modified pulse signal s71 (FIG. 26(f)). For example, the pulse signal s1 is outputted when the control signal s13 outputted from the comparator 13 is “L” level, while the output s72 from the inversion circuit 72 is outputted when the control signal s13 is “H” level.

As the result of the above-described operation, mark lengths or space lengths longer than the reference value (“7T”) stored in the reference value holding circuit 16, which are included in the pulse signal s1 (FIG. 26(b)) inputted to the write correction circuit 700, are modified to the length of the maximum value (the reference value stored in the reference value holding circuit 16) as shown in FIG. 26(f), thereby obtaining a modified pulse signal s71 including no too-long sections (patterns).

Thereafter, the modified pulse signal s71 is inputted to the space/mark length detection unit 7 of the write correction circuit 700, and write correction similar to that of the prior art is performed to the modified pulse signal s71. Since this operation is identical to that described for the prior art, repeated description is not necessary.

As described above, according to the seventh embodiment, after the pulse modification circuit 71 provided in the input stage of the write correction circuit 700 modifies the input pulse signal s1, write correction is carried out using the modified pulse signal s71. Therefore, desired write correction can be always performed to the pulse signal s1 that is inputted to the write correction circuit 700, resulting in highly precise write correction.

Further, according to the seventh embodiment, in the pulse modification circuit 71, the respective count values of the mark sections and the space sections of the pulse signal s1 are detected, and each count value is compared with the predetermined reference value. When the count value is equal to or smaller than the reference value, the pulse signal s1 is outputted. On the other hand, when the count value is larger than the reference value, not the pulse signal s1 but the output s72 from the inversion circuit 72 is outputted. Therefore, it is possible to perform modification such that the mark sections and space sections longer than the predetermined length are not included in the pulse signal s1.

While in this seventh embodiment the space/mark counter 12 is identical to that of the first embodiment, the space/mark counter 12 may have the same construction as that of the second or fourth embodiment.

While in this seventh embodiment the reference value holding circuit 16 holds the too-long reference value as the section length of the write pulse signal s1, a reference value may be selected according to the combination of plural count values outputted from the space/mark counter as described for the fifth embodiment, or a reference value may be selected according to the recording medium on which the pulse signal s1 is written, or the write mode.

Furthermore, two pulse modification circuits may be provided in the write correction circuit. For example, when the pulse modification circuit 11 described for the first embodiment and the pulse modification circuit 71 described for the seventh embodiment are provided in the write correction circuit in conjunction with each other, the write pulse signal s1 inputted to the write correction circuit is initially modified so as to remove too-short sections included in the pulse signal s1 by the pulse modification circuit 11, and thereafter, the lengths of too-long sections included in the modified pulse signal are modified to the predetermined length by the pulse modification circuit 71, thereby realizing more precise write correction.

### APPLICABILITY IN INDUSTRY

A write correction circuit according to the present invention is useful as one providing such as an optical information recording apparatus capable of performing write correction at high precision. Further, it is also applicable to such as a communication device that needs write correction.

1. A write correction circuit comprising:
a pulse modification circuit for modifying the lengths of space sections and mark sections in a write pulse signal for recording information on a recording medium, said space sections and mark sections having the lengths which are outside a range that is previously set as a section length of the write pulse signal;
a space/mark length detection circuit for detecting the space length and the mark length of the write pulse signal, which are modified by the pulse modification circuit;
an address generation/timing control circuit for performing address generation and timing control when recording information on the recording medium, on the basis of the outputs of the space length and the mark length that are detected by the space/mark length detection circuit;
a multiple phase signal output circuit for generating multiple phase signals by shifting the phase of an input clock signal, and outputting the multiple phase signals; and
a timing generation circuit for generating a write correction signal on the basis of the output of the address generation/timing control circuit and the output of the multiple phase signal output circuit, and outputting the write correction signal.

2. A write correction circuit as defined in claim 1 wherein said pulse modification circuit includes:
a space/mark counter for detecting the count values of space sections and mark sections of the write pulse signal, and outputting the detected count values;
a reference value holding circuit for holding, as a reference value, a value shorter than the length that is previously set as the section length of the write pulse signal;
a comparator for comparing the count value outputted from the space/mark counter with the reference value to detect a period in which the count value becomes equal to or smaller than the reference value; and
a selection circuit for receiving the write pulse signal and a signal that is outputted from the selection circuit at an immediately previous timing, and selecting and outputting the signal that is outputted from the selection circuit at the immediately previous timing during the period in which the count value is equal to or smaller than the reference value, which period is detected by the comparator, while selecting and outputting the write pulse signal during other periods.

3. A write correction circuit as defined in claim 2 wherein said space/mark counter includes:
a space counter for counting space sections of the write pulse signal;
a mark counter for counting mark sections of the write pulse signal;
an edge detector for detecting a rising edge and a falling edge of the write pulse signal; and
a switching circuit for switchingly outputting the count value of the space counter and the count value of the mark counter at the timings of the rising edge and the falling edge which are outputted from the edge detector;
wherein said comparator in the pulse modification circuit compares the count value of the space section or the mark section outputted from the switching circuit with the reference value, and outputs a signal that is outputted from the selection circuit at an immediately previous timing when the count value of the space section or the mark section is equal to or smaller than the reference value, while the comparator outputs the write pulse signal when the count value is larger than the reference value.

4. A write correction circuit as defined in claim 2 wherein said space/mark counter includes:
a space counter for counting space sections of the write pulse signal;
a mark counter for counting mark sections of the write pulse signal;
an edge detector for detecting a rising edge and a falling edge of the write pulse signal;
a switching circuit for switchingly outputting the count value of the space counter and the count value of the mark counter at the timings of the rising edge and the falling edge which are outputted from the edge detector; and
a section delay circuit for continuously outputting the count value of the space section or the mark section which is outputted from the switching circuit at an immediately previous timing, during the period in which the write pulse signal rises and the period in which the write pulse signal falls;
wherein said comparator in the pulse modification circuit compares the count value of the space section or the mark section outputted from the section delay circuit with the reference value, and outputs a signal that is outputted from the selection circuit at an immediately previous timing when the count value of the space section or the mark section outputted from the section delay circuit is equal to or smaller than the reference value, while the comparator outputs the write pulse signal when the count value is larger than the reference value.

5. A write correction circuit as defined in claim 2 wherein
said pulse modification circuit includes a period restriction circuit for restricting the period detected by the comparator to a length equal to or shorter than a predetermined period length; and
said selection circuit selects and outputs a signal that is outputted from the selection circuit at an immediately previous timing, during the period that is detected by the comparator and restricted by the period restriction circuit, while the selection circuit selects and outputs the write pulse signal during other periods.

6. A write correction circuit as defined in claim 3 wherein said space/mark counter includes:
a section delay circuit for continuously outputting the count value of the space section or the mark section that is outputted from the switching circuit at an immediately previous timing, during the period in which the write pulse signal rises and the period in which the write pulse signal falls; and
a count value selection circuit for selecting either the output from the switching circuit or the output from the section delay circuit on the basis of an externally inputted selection signal;
wherein said comparator in the pulse modification circuit compares the count value of the space section or the mark section which is outputted from the switching circuit with the reference value when the output from the switching circuit is selected by the count value selection circuit, while it compares the count value of the immediately previous space section or mark section which is outputted from the section delay circuit with the reference value when the output from the section delay circuit is selected.

7. A write correction circuit as defined in claim 1 wherein said pulse modification circuit includes:
a space/mark counter for detecting a first count value that is a count value of a space section or a mark section of the write pulse signal, and second to N-th count values that are count values of mark sections or space sections which are by 1□(N−1) pieces (N: integer not less than 3) previous to the first count value;
a reference value holding circuit for holding plural reference values that have previously been set for each combination of N pieces of count values from the first to N-th count values which are outputted at the same timing from the space/mark counter;
a comparator for comparing the first count value with a reference value that is selected according to the combination of the N pieces of values to detect a period in which the first count value becomes equal to or smaller than the selected reference value; and
a selection circuit for receiving the write pulse signal and a signal that is outputted from the selection circuit at an immediately previous timing, and selecting and outputting the signal that is outputted from the selection circuit at the immediately previous timing during the period in which the count value is equal to or smaller than the reference value, which period is detected by the comparator, while selecting and outputting the write pulse signal during other periods.

8. A write correction circuit as defined in claim 1 wherein said pulse modification circuit includes:
a space/mark counter for detecting the count values of space sections and mark sections of the write pulse signal, and outputting the detected count values;
a reference value holding circuit for holding plural pieces of reference values that have previously been set for plural kinds of writing modes for writing the write pulse signal on the recording medium, respectively;
a comparator for comparing the count value outputted from the space/mark counter with a reference value that is selected according to the writing mode of the write pulse signal to detect a period in which the count value becomes equal to or smaller than the selected reference value; and
a selection circuit for receiving the write pulse signal and a signal that is outputted from the selection circuit at an immediately previous timing, and selecting and outputting the signal that is outputted from the selection circuit at the immediately previous timing during the period in which the count value is equal to or smaller than the selected reference value, which period is detected by the comparator, while selecting and outputting the write pulse signal during other periods.

9. A write correction circuit as defined in claim 1 wherein said pulse modification circuit includes:
a space/mark counter for detecting the count values of space sections and mark sections of the write pulse signal, and outputting the detected count values;
a reference value holding circuit for holding plural pieces of reference values that have previously been set for plural kinds of recording media on which the write pulse signal is written, respectively;
a comparator for comparing the count value outputted from the space/mark counter with a reference value that is selected according to the recording medium on which the write pulse signal is written, thereby to detect a period in which the count value becomes equal to or smaller than the selected reference value; and
a selection circuit for receiving the write pulse signal and a signal that is outputted from the selection circuit at an immediately previous timing, and selecting and outputting the signal that is outputted from the selection circuit at the immediately previous timing during the period in which the count value is equal to or smaller than the selected reference value, which period is detected by the comparator, while selecting and outputting the write pulse signal during other periods.

10. A write correction circuit as defined in claim 1 wherein said pulse modification circuit includes:
a space/mark counter for detecting the count values of space sections and mark sections of the write pulse signal, and outputting the detected count values;
a reference value holding circuit for holding, as a reference value, a value longer than a length that is previously set as a section length of the write pulse signal;
a comparator for comparing the count value outputted from the space/mark counter with the reference value to detect a period in which the count value becomes equal to or larger than the selected reference value;
an inversion circuit for inverting the write pulse signal; and
a selection circuit for receiving the write pulse signal and an inverted signal that is outputted from the inversion circuit, and selecting and outputting the inverted signal during the period in which the count value is equal to or larger than the reference value, which period is detected by the comparator, while selecting and outputting the write pulse signal during other periods.

11. A write correction method comprising:
a pulse modification step of modifying the lengths of space sections and mark sections in a write pulse signal used for recording information on a recording medium, which lengths are outside a range that is previously set as a section length of the write pulse signal;
a space/mark length detection step of detecting the space length and the mark length of the write pulse signal, which are modified in the pulse modification step;
an address generation/timing control step of performing address generation and timing control for recording information on the recording medium, on the basis of the outputs of the space length and the mark length detected in the space/mark length detection step;
a multiple phase signal output step of generating multiple phase signals by shifting the phase of an input clock signal, and outputting the multiple phase signals; and
a timing generation step of generating a write correction signal on the basis of the output of the address generation/timing control step and the output of the multiple phase signal output step, and outputting the write correction signal.

12. A write correction method as defined in claim 11 wherein said pulse modification step modifies, in the write pulse signal, a space section equal to or smaller than a reference value which is shorter than the length that is previously set as a section length of the write pulse signal, to a mark section, and modifies a mark section equal to or smaller than the reference value to a space section.

13. A write correction method as defined in claim 11 wherein said pulse modification step modifies, in the write pulse signal, a mark section next to a space section equal to or smaller than a reference value which is shorter than the length that is previously set as a section length of the write pulse signal, to a space section, and modifies a space section next to a mark section equal to or smaller than the reference value to a mark section.

14. A write correction method as defined in claim 11 wherein
said pulse correction step modifies, in the write pulse signal, a mark section next to a space section equal to or smaller than a reference value which is shorter than the length that is previously set as a section length of the write pulse signal, to a space section, and modifies a space section next to a mark section equal to or smaller than the reference value to a mark section, and
when the lengths of the mark section and the space section after the modification are equal to or longer than a predetermined length, said pulse correction step restricts the space section of the portion equal to or longer than the predetermined length to a mark section, and restricts the mark section of the portion equal to or longer than the predetermined length to a space section.

15. A write correction method as defined in claim 12 wherein
a plurality of reference values have previously been set for each combination of section lengths of continuous plural space sections or mark sections of the write pulse signal, and
said pulse modification step modifies, in the write pulse signal, a space section that is equal to or smaller than a reference value which is selected according to the combination of the section lengths of the plural space sections or mark sections, to a mark section, and modifies a mark section equal to or smaller than the selected reference value to a space section.

16. A write correction method as defined in claim 12 wherein
a plurality of reference values have previously been set for plural kinds of recording media on which the write pulse signal is to be written, respectively, and
said pulse modification step modifies, in the write pulse signal, a space section that is equal to or smaller than a reference value which is selected according to the recording medium on which the write pulse signal is written, to a mark section, and modifies a mark section equal to or smaller than the selected reference value to a space section.

17. A write correction method as defined in claim 12 wherein
a plurality of reference values have previously been set for plural kinds of recording modes for writing the write pulse signal on a recording medium, respectively, and
said pulse modification step modifies, in the write pulse signal, a space section that is equal to or smaller than a reference value which is selected according to the recording mode of the write pulse signal, to a mark section, and modifies a mark section equal to or smaller than the selected reference value to a space section.

18. A write correction method as defined in claim 11 wherein said pulse modification step modifies, in the write pulse signal, a space section equal to or larger than a reference value which is a value longer than the length that is previously set as a section length of the write pulse signal, to a mark section, and modifies a mark section equal to or larger than the reference value to a space section.
